(19) United States
(12) Patent Application Publication
(10) Pub. No.: US 2021/0403107 A1
(43) Pub. Date: Dec. 30, 2021

(54) ELASTIC CRAWLER

(71) Applicant: BRIDGESTONE CORPORATION, Chuo-ku, Tokyo (JP)

(72) Inventor: Ryo MIYAMOTO, Chuo-ku, Tokyo (JP)

(73) Assignee: BRIDGESTONE CORPORATION, Chuo-ku, Tokyo (JP)

(21) Appl. No.: 17/281,326

(22) PCT Filed: Oct. 16, 2019
(86) PCT No.: PCT/JP2019/040773

§ 371 Date: Mar. 30, 2021

(30) Foreign Application Priority Data
Oct. 16, 2018 (JP) 2018-195086

(51) Int. Cl. B62D 55/24

(52) U.S. Cl. CPC B62D 55/24; B62D 55/14

(57) ABSTRACT

Provided is a novel elastic crawler with improved durability. An elastic crawler (1A) includes: a crawler body (2) made of an elastic material; a projection (3) arranged on an inner circumferential surface (21) of the crawler body (2) and made of an elastic material; and a resin member (31) forming a part of the projection (3). The resin member (31) is embedded in the projection (3) such that a lowermost end (31e) of the resin member (31) is arranged at a position higher than a lowermost end (3e) of the projection (3), and a part of the resin member (31) is exposed on a crawler-width-direction side surface (3b1) of the projection (3) and forms a crawler-width-direction side surface (2b1) of the projection (3).

### TECHNICAL FIELD

The disclosure relates to an elastic crawler.

### BACKGROUND

An example of a conventional elastic crawler includes a rubber crawler (see PTL 1, for example) in which a resin member is integrally provided on a projection provided on an inner circumferential surface of a crawler body and the resin member is exposed on a surface in contact with other members in the projection. According to the elastic crawler disclosed in PTL 1, an elastic crawler with excellent durability can be provided.

### CITATION LIST

### Patent Literature

PTL 1: JP-A-2007-210447

### SUMMARY

### Technical Problem

However, the conventional elastic crawler also has room for further improvement in terms of improving durability.

An object of the disclosure is to provide a novel elastic crawler with improved durability.

### Solution to Problem

An elastic crawler according to the disclosure includes: a crawler body formed in an endless belt shape and made of an elastic material; a projection arranged on an inner circumferential surface of the crawler body and containing an elastic material; and a resin member forming a part of the projection, wherein the resin member is embedded in the projection such that a lowermost end of the resin member is arranged at a position higher than a lowermost end of the projection, and a part of the resin member is exposed on a crawler-width-direction side surface of the projection. According to the elastic crawler of the disclosure, a novel elastic crawler with improved durability is provided.

In the elastic crawler according to the disclosure, other parts of the resin member are preferably exposed on a top surface of the projection. In this case, durability of the projection can be further improved.

In the elastic crawler according to the disclosure, the resin member may include two base portions arranged in a crawler width direction to face each other and at least one connecting portion configured to connect the two base portions to each other, and a region may be partitioned between the base portion and the connecting portion to accommodate other portions forming the projection. In this case, the durability of the projection can be further improved.

Particularly, in the elastic crawler according to the disclosure, the resin member preferably includes at least one of a concave portion and a convex portion on an embedded surface in contact with the projection. In this case, the durability of the projection of the elastic crawler and the durability of the elastic crawler can be further improved.

In the elastic crawler according to the disclosure, a crawler-width-direction outer corner portion of the resin member preferably has a rounded shape from an outer surface of the resin member toward an inner surface of the resin member in a crawler-width-direction cross section view. In this case, the durability is further improved.

In the elastic crawler according to the disclosure, the resin member preferably includes a flat portion that is continuous with the crawler-width-direction outer corner portion and extends flatly toward the inner surface of the resin member in the crawler-width-direction cross section view. In this case, the durability is further improved.

In the elastic crawler according to the disclosure, a crawler-width-direction inner corner portion of the resin member preferably has a rounded shape from the inner surface of the resin member toward the outer surface of the resin member in the crawler-width-direction cross section view. In this case, the durability is further improved.

### Advantageous Effect

According to the disclosure, a novel elastic crawler with improved durability can be provided.

### BRIEF DESCRIPTION OF THE DRAWINGS

In the accompanying drawings:

FIG. 1 is a side view schematically illustrating an example of a crawler running apparatus to which an elastic crawler according to a first embodiment of the disclosure can be applied;

FIG. 2 is a perspective view of the elastic crawler according to the first embodiment of the disclosure in a partial cross section;

FIG. 3 is a partial plan view illustrating an enlarged inner circumferential surface of the elastic crawler in FIG. 2;

FIG. 4 is a cross-sectional view taken along a line A-A in FIG. 3;

FIG. 5 is a cross-sectional view taken along a line B-B in FIG. 3;

FIG. 6A is a plan view schematically illustrating a resin member forming a part of the projection of the elastic crawler in FIG. 2;

FIG. 6B is a front view of FIG. 6A;

FIG. 6C is a side view of FIG. 6A;

FIG. 6D is a bottom view of FIG. 6A;

FIG. 6E is a bottom perspective view of FIG. 6A;

FIG. 7 is an enlarged perspective view schematically illustrating a projection of an elastic crawler according to a second embodiment of the disclosure;

FIG. 8 is a perspective view schematically illustrating a resin member forming a part of the projection of the elastic crawler in FIG. 7 when viewed from a plane side;

FIG. 9 is a perspective view schematically illustrating the resin member forming a part of the projection of the elastic crawler in FIG. 7 when viewed from a back side;

FIG. 10 is a perspective view illustrating a partial cross section of an elastic crawler according to an embodiment of the disclosure;

FIG. 11 is a partially enlarged plan view of an inner circumferential surface of the elastic crawler in FIG. 10;

FIG. 12A is a plan view schematically illustrating a resin member forming a part of the projection of the elastic crawler in FIG. 10;

FIG. 12B is a bottom view of the resin member illustrated in FIG. 12A;

FIG. 12C is a front view of the resin member illustrated in FIG. 12A;

FIG. 12D is a side view of the resin member illustrated in FIG. 12A;

FIG. 12E is a cross-sectional view taken along a line C-C in FIG. 12B;

FIG. 12F is a perspective view illustrating the resin member in FIG. 12A when the resin member is viewed from a bottom;

FIG. 13A is a cross-sectional view taken along a line A-A in FIG. 11; and

FIG. 13B is an enlarged cross-sectional view illustrating a region X in FIG. 13A.

### DETAILED DESCRIPTION

Hereinafter, elastic crawlers according to various embodiments of the disclosure will be described with reference to the drawings. In the description, a “crawler width direction”, a “crawler thickness direction”, and a “crawler circumferential direction” refer to directions based on a crawler body (here, synonymous with an “elastic crawler”). In the drawings, the crawler width direction is indicated by an arrow WD, the crawler thickness direction is indicated by an arrow TD, and the crawler circumferential direction is indicated by an arrow CD. In the description, a “crawler inner circumferential side” and a “crawler outer circumferential side” also refer to an “inner circumferential side” and an “outer circumferential side” based on the crawler body (here, synonymous with an “elastic crawler”), respectively. Further, in the description, a “crawler-thickness-direction outer circumferential side” refers to a crawler outer circumferential side out of both sides in the crawler thickness direction, and also simply refers to a “lower side”. In the description, a “crawler-thickness-direction inner circumferential side” refers to a crawler inner circumferential side out of both sides in the crawler thickness direction, and also simply refers to an “upper side”.

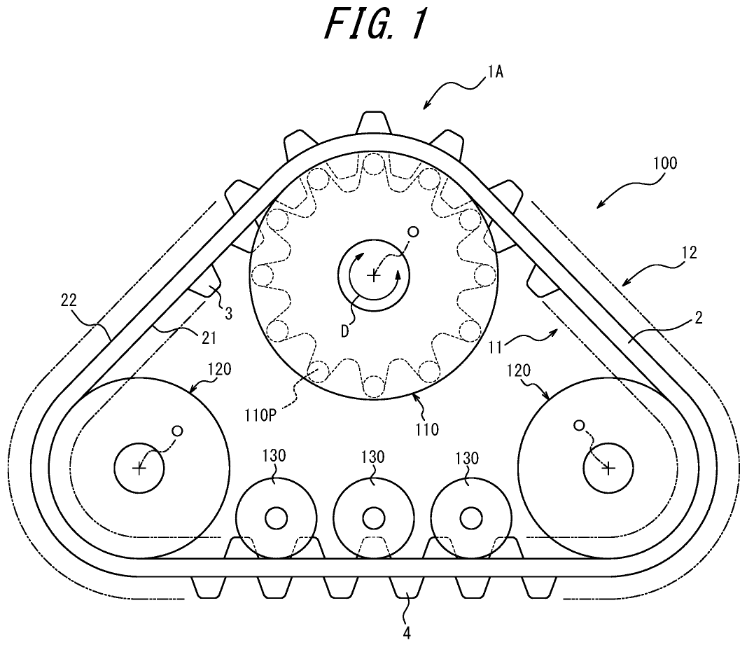

FIG. 1 is a side view schematically illustrating an example of a crawler running apparatus 100 to which an elastic crawler 1A according to a first embodiment of the disclosure can be applied. The crawler running apparatus 100 is used in a state of being mounted on, for example, an agricultural machines (a tractor, a combine, or the like) or a construction machine (a compact excavator or the like).

In this example, the crawler running apparatus 100 includes a drive wheel (sprocket) 110, an idling wheel (idler) 120, and a track roller 130, which are attached to a vehicle (not illustrated). In this example, the drive wheel 110 is a cage-type sprocket. The cage-type sprocket includes a plurality of pins 110 P arranged around a rotation axis O with the same pitch (in FIG. 1, only one is denoted by a reference numeral as an example). In this example, the crawler running apparatus 100 includes one drive wheel 110, two idling wheels 120, and three track rollers 130, but each of the components can be changed depending on the configuration of the crawler running apparatus 100. In other words, one drive wheel 110, one idling wheel 120, and one track roller 130 may be provided. In the crawler running apparatus 100 of this example, the pin 110P is formed in a cylindrical shape extending in the crawler width direction, but the configuration of the pin 110P can be changed as appropriate.

In addition, the crawler running apparatus 100 includes an elastic crawler 1A according to the first embodiment of the disclosure. The elastic crawler 1A is wound around the drive wheel 110, the idling wheel 120, and the track roller 130. The elastic crawler 1A includes a crawler body 2 formed in an endless belt shape and made of an elastic material, projections 3 (in FIG. 1, one projection is denoted by a reference numeral as an example) arranged on an inner circumferential surface of the crawler body 2 and containing an elastic material, and lug 4 arranged on an outer circumferential surface of the crawler body 2 and made of an elastic material. In this example, all of the elastic materials are rubber. The projection 3 and the lug 4 can be integrally formed together with the crawler body 2, and can adhere to the crawler body 2 in a fashion of vulcanization.

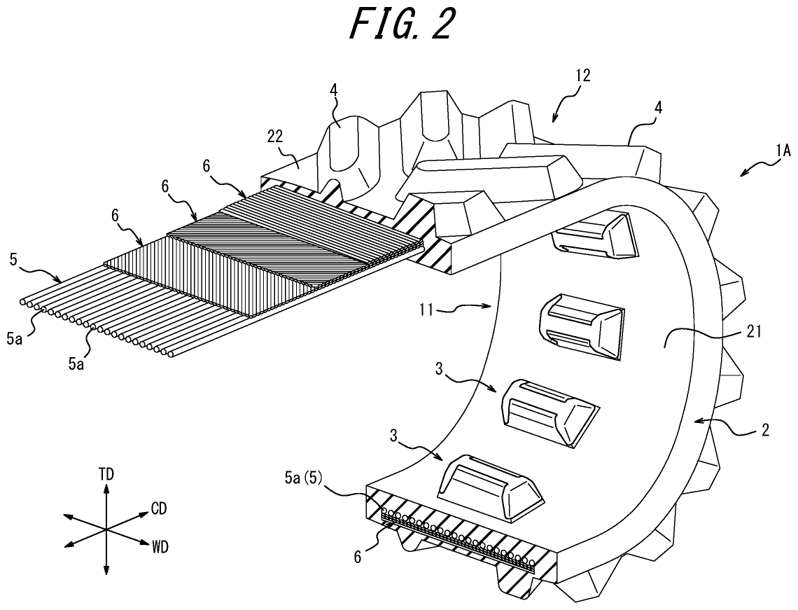

FIG. 2 illustrates a partial cross section of the elastic crawler 1A.

The elastic crawler 1A according to the present embodiment is a coreless rubber crawler. In the present embodiment, the crawler body 2 includes a steel cord layer 5 embedded inside the crawler body 2 and reinforcing ply 6 having one or a plurality of layer (three layers in an example of the drawing).

As illustrated in FIG. 2, each of the plurality of projections 3 projects from an inner circumferential surface 21 of the crawler body 2 toward the crawler inner circumferential side. In addition, the plurality of projections 3 is arranged with a regular distance from each other in the crawler circumferential direction. In the present embodiment, each of the projections 3 is arranged at a center of the crawler body 2 in the crawler width direction. In the present embodiment, an inner circumferential surface 11 of the elastic crawler 1A is formed by the inner circumferential surface 21 of the crawler body 2 and surfaces of the projections 3.

Each of the plurality of lugs 4 protrudes from an outer circumferential surface 22 of the crawler body 2 toward the crawler outer circumferential side. Shape and arrangements of the lugs 4 are not limited to those illustrated in each of the drawings, and any shapes and arrangements can be employed. In the present embodiment, an outer circumferential surface 12 of the elastic crawler 1A is formed by the outer circumferential surface 22 of the crawler body 2 and surfaces of the respective lugs 4.

Each of the steel cord layers 5 is made up of a plurality of steel cords 5a extending in parallel in the crawler circumferential direction. Each of the reinforcing plies 6 is arranged closer to the crawler outer circumferential side from the steel cord layers 5. The reinforcing ply 6 includes a plurality of cords which is inclined in the crawler circumferential direction, for example. Further, the reinforcing ply 6 may be omitted.

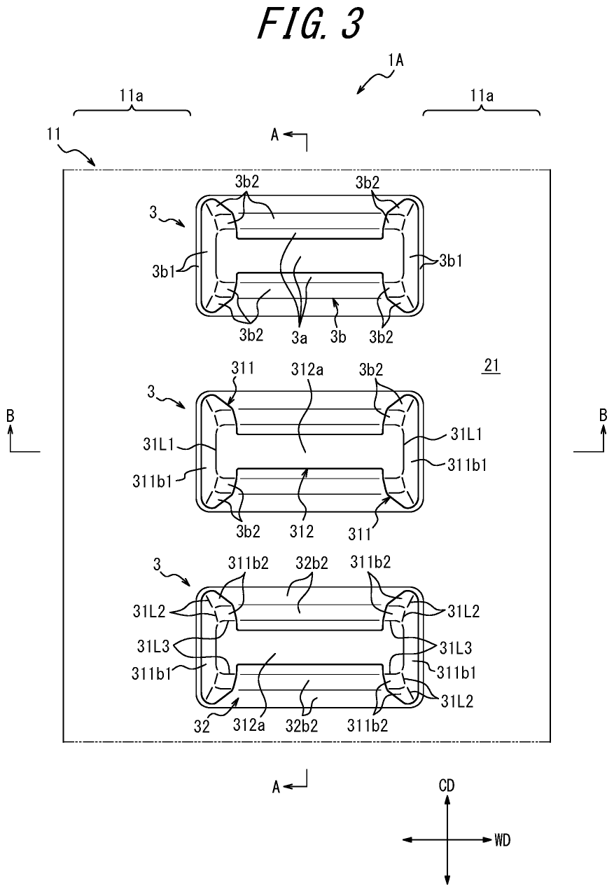

FIG. 3 illustrates an enlarged inner circumferential surface 11 of the elastic crawler 1A. In the present embodiment, as illustrated in FIG. 3, the projection 3 includes a top surface 3a and a side surface 3b. The top surface 3a is an end surface, which is located on the crawler inner circumferential side of the projection 3, in the outer surface of the projection 3. The side surface 3b is an outer surface other than the top surface 3a in the outer surface of the projection 3. In the present embodiment, the side surface 3b includes a crawler-width-direction side surface (a crawler-width-direction side surface of the projection 3) 3b1 and a crawler-circumferential-direction side surface (a crawler-circumferential-direction side surface of the projection 3) 3b2. In the present embodiment, track roller passing surfaces 11a (which will be described below) are provided on outer sides in the crawler width direction of the projection 3. Each of the track roller passing surfaces 11a is provided on the inner circumferential surface 21 of the crawler body 2.

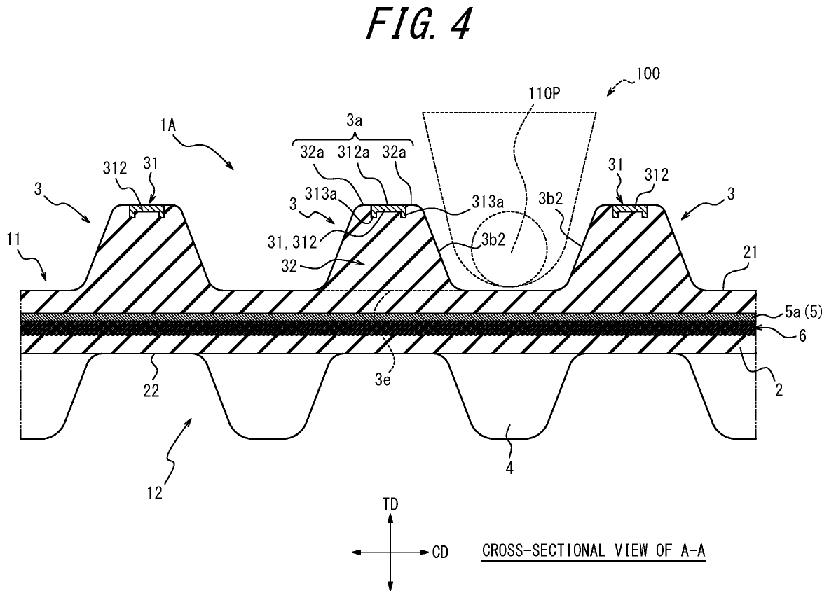

FIG. 4 is a cross-sectional view taken along a line A-A in FIG. 3. FIG. 4 illustrates a cross section of the elastic crawler 1A including the crawler thickness direction in the crawler circumferential direction. The crawler running apparatus 100 illustrated in FIG. 1 is configured as a running apparatus for a tractor. As indicated by an arrow D in FIG. 1, when the drive wheel 110 rotates around the rotation axis O, as illustrated in FIG. 4, the respective pins 110P are configured to sequentially contact with a crawler-circumferential-direction side surface 3b2 of the projection 3 of the elastic crawler 1A corresponding to the pin 110P. The projection 3 has a function of transmitting a driving force to the crawler body 2 from the pin 110P when the pin 110P of the drive wheel 110 comes into contact with the crawler-circumferential-direction side surface 3b2 of the projection 3.

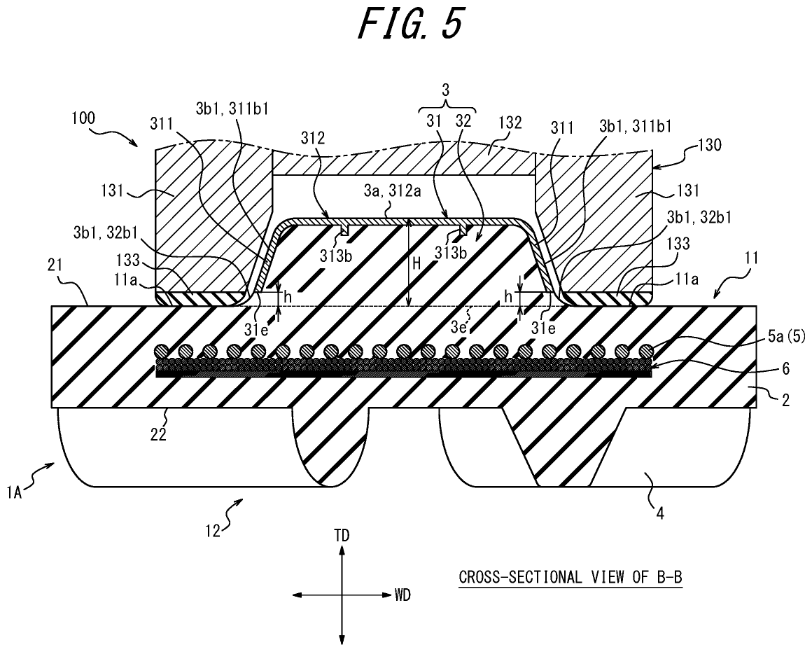

FIG. 5 is a cross-sectional view taken along a line B-B in FIG. 3. FIG. 5 illustrates a cross section of the elastic crawler 1A including the crawler thickness direction in the crawler width direction. As illustrated in FIG. 5, in the crawler running apparatus 100 of this example to which the elastic crawler 1A according to the present embodiment can be applied, the track roller 130 includes two track roller bodies 131 arranged with a distance in the crawler width direction and a connecting shaft 132 configured to connect the track roller bodies 131 with each other, and an outer circumferential surface of the track roller body 131 is covered with a rubber portion 133. In the crawler running apparatus 100 of this example, each of the track rollers 130 is configured to roll on the track roller passing surface 11a (see FIGS. 3 and 5). In other words, the elastic crawler 1A is configured to pass over the track roller 130 during running.

In the crawler running apparatus 100 of this example, the projections 3 of the elastic crawler 1A are configured to be arranged inside the two track roller bodies 131 in the crawler width direction. The projection 3 has a function of guiding the track roller 130 in the crawler width direction by the crawler-width-direction side surface 3b1 of the projection 3. Thus, derailing of the elastic crawler 1A (disengaging of the elastic crawler 1A from the rotating body of the track roller 130) is prevented. In this example, the idling wheel 120 is also configured in the same manner as the track roller 130. Thus, derailing of the elastic crawler 1 from the idling wheel 120 is also prevented. The elastic crawler 1A according to the present embodiment may be employed for a crawler running apparatus having an arbitrary configuration different from that of the crawler running apparatus 100 illustrated in FIG. 1.

Incidentally, the elastic crawler 1A according to the present embodiment includes a resin member 31 that forms a part of the projection 3. The resin member 31 is embedded in the projection 3 such that a lowermost end 31e of the resin member 31 is arranged at a position higher than a lowermost end 3e of the projection 3.

As illustrated in FIG. 5 and the like, a height H of the projection 3 is a height in the crawler thickness direction. In the elastic crawler 1A according to the present embodiment, the height H of the projection 3 is a height from the lowermost end 3e to the top surface 3a of the projection 3. Here, the lowermost end 3e of the projection 3 is a boundary surface between the projection 3 and the crawler body 2. As indicated by a broken line in FIG. 5 and the like, in the present embodiment, the lowermost end 3e of the projection 3 is a virtual bond surface, which coincides with the inner circumferential surface 21 of the crawler body 2, of the projection 3.

More specifically, in the elastic crawler 1A according to the present embodiment, the projection 3 includes a resin member 31 and an elastic projection 32. The elastic projection 32 is an elastic projection provided on the inner circumferential surface 21 of the crawler body 2. The elastic projections 32 are arranged with regular distances from each other in the crawler circumferential direction. In the present embodiment, the elastic projection 32 protrudes from the inner circumferential surface 21 of the crawler body 2 toward the crawler inner circumferential side.

In the elastic crawler 1A according to the present embodiment, the elastic projection 32 is a rubber projection made of rubber that absorbs an impact from the outside. On the other hand, the resin member 31 is provided to reinforce the elastic projection 32 and to prevent abrasion and breakage of the elastic projection 32. An example of the resin material constituting the resin member 31 may include a resin material having higher rigidity (for example, strength) and a lower coefficient of friction than a rubber material constituting the elastic projection 32. In the present embodiment, the projection 3 can be formed, for example, in a manner that the resin member 31 adheres to the elastic projection 32 or the elastic projection 32 is formed with unvulcanized rubber using the resin member 31 as an insert article. In other words, the projection 3 can be formed by chemical or physical bonding of the resin member 31 and the elastic projection 32.

In the elastic crawler 1A according to the present embodiment, a resin members 31 is embedded in each elastic projection 32. In the present embodiment, the surface of the resin member 31 is partially exposed on the outer surface of the elastic projection 32. The rest of the resin member 31 excluding the exposed part is embedded inside the elastic projection 32. The outer surface of the resin member 31 and the outer surface of the elastic projection 32 form the outer surface of the projection 3. In the present embodiment, the outer surface of the resin member 31 and the outer surface of the elastic projection 32 smoothly form the outer surface of the projection 3 without a step therebetween. In other words, the outer surface of the projection 3 is the same level surface (for example, the same flat surface) formed by the outer surface of the resin member 31 and the outer surface of the elastic projection 32. However, a step may exist between the outer surface of the resin member 31 and the outer surface of the elastic projection 32. For example, when a part of the resin member 31 protrudes outward from the outer surface of the elastic projection 32, a step may arise on the outer surface of the projection 3.

As illustrated in FIG. 5, the resin member 31 is embedded in the projection 3 such that the lowermost end 31e of the resin member 31 is arranged at a position higher than a lower end 3e of the projection 3. Here, the lowermost end 31e of the resin member 31 is a part of the resin member 31 and is closest to the lowermost end 3e of the projection 3 in the crawler thickness direction.

Further, as illustrated in FIG. 5 and the like, in the elastic crawler 1A according to the present embodiment, a part of the resin member 31 is exposed on the crawler-width-direction side surface 3b1 of the projection 3, and forms at least a part of the crawler-width-direction side surface 3b1 of the projection 3.

In the elastic crawler 1A according to the present embodiment, the resin member 31 includes two base portions 311 arranged in the crawler width direction to face each other. Each of the base portions 311 is embedded in a side of the elastic projection 32 in the crawler width direction. Each of the base portions 311 includes a crawler-width-direction side surface 311b1 forming the crawler-width-direction side surface 3b1 of the projection 3. In other words, in the present embodiment, the crawler-width-direction side surface 311b1 of the base portion 311 of the resin member 31 is exposed, as a part of the resin member 31, on the crawler-width-direction side surface 3b1 of the projection 3.

In the present embodiment, the crawler-width-direction side surface 3b1 of the projection 3 includes the crawler-width-direction side surface 311b1 of the base portion 311 of the resin member 31 and a crawler-width-direction side surface 32b1 of the elastic projection 32. In the present embodiment, a step does not exist between the crawler-width-direction side surface 311b1 of the base portion 311 of the resin member 31 and the crawler-width-direction side surface 32b1 of the elastic projection 32, and the crawler-width-direction side surface 3b1 of the projection 3 is smoothly formed. In other words, the crawler-width-direction side surface 3b1 of the projection 3 is the same level surface (for example, the same flat surface) formed by the crawler-width-direction side surface 311b1 of the base portion 311 of the resin member 31 and the crawler-width-direction side surface 32b1 of the elastic projection 32.

In the elastic crawler 1A according to the present embodiment, the lowermost end 31e of the resin member 31 is a lowermost end of the base portion 311. In the present embodiment, the lowermost end 31e of the resin member 31 is located at a height h (>0) from the lowermost end 3e of the projection 3. The height h is a height in the crawler thickness direction. The height h can be appropriately set according to various requirements such as dimensions, shapes, and required performance of the elastic crawler 1A. For example, in the present embodiment, the height h is set higher than a thickness of the rubber portion 133 in the crawler thickness direction so as to prevent direct contact of the resin member 31 with the rubber portion 133 (see FIG. 5) of the track roller 130 on which the elastic crawler 1A can be mounted.

As illustrated in FIG. 4, the pin 110P of the drive wheel 110 can be hooked on the projection 3 arranged on the inner circumferential surface 21 of the crawler body 2. Thus, the pin 110P pulls the elastic crawler 1A as the drive wheel 110 rotates, and thus the driving force caused by the rotation of the drive wheel 110 is transmitted to the elastic crawler 1A.

On the other hand, when elastic crawler 1A is driven, stress concentration arises at the lowermost end (the virtual bond surface of the projection 3) 3e of the projection 3 of the elastic crawler 1A. Therefore, when the stress concentration is prevented from arising at the lowermost end 3e of the projection 3 provided on the elastic crawler 1A, durability of the projection 3 of the elastic crawler 1A is improved and durability of the elastic crawler 1A is eventually improved.

However, the inventors of the disclosure has found that the stress concentration increases due to the difference in rigidity generated at the lowermost end 3e of the projection 3 when the lowermost end 31e of the resin member 31 embedded in the projection 3 reaches a position corresponding to the lowermost end 3e of the projection 3.

Therefore, as illustrated in FIG. 5, in the elastic crawler 1A according to the present embodiment, the resin member 31 is arranged at a position where the lowermost end 31e of the resin member 31 is higher than the lowermost end (the virtual bond surface of the projection 3) 3e of the projection 3. In this case, since the lowermost end (the virtual bond surface of the projection 3) 3e of the projection 3 of the elastic crawler 1A is made of only the same material, it is possible to prevent the stress concentration, which may arise at the lowermost end 3e of the projection 3 of the elastic crawler 1A, due to different materials.

On the other hand, when the elastic crawler 1A is driven, the rotating body such as the track roller 130 rolls on the track roller passing surfaces 11a arranged on both side of the projection 3 in the crawler width direction. When the elastic crawler 1A tries to move in the crawler width direction with respect to the rotating body, the projection 3 of the elastic crawler 1A functions to guide the elastic crawler 1A in the crawler width direction by contact with the rotating body. Such a guide function is particularly large on the crawler-width-direction side surface 3b1 of the projection 3. In other words, the projection 3 of the elastic crawler 1A suffers a large load on the crawler-width-direction side surface 3b1 of the projection 3. In particular, when the vehicle turns, a load on the crawler-width-direction side surface 3b1 of the projection 3 of the elastic crawler 1A becomes larger.

Therefore, in the elastic crawler 1A according to the present embodiment, the crawler-width-direction side surface 311b1 of the base portion 311 of the resin member 31 is exposed, as a part of the resin member 31, on the crawler-width-direction side surface 3b1 of the projection 3, and forms the crawler-width-direction side surface 3b1 of the projection 3. In this case, the crawler-width-direction side surface 3b1 of the projection 3 can be protected by the base portion 311 of the resin member 31.

Accordingly, the elastic crawler 1A according to the present embodiment is a new elastic crawler with improved durability. Further, the resin member 31 has a lower coefficient of friction than rubber. For this reason, even when the rotating body such as the track roller 130 tries to ride on the projection 3, the rotating body slips down, and thus the derailing of the elastic crawler 1A hardly occurs.

In the elastic crawler 1A according to the present embodiment, the other part of the resin member 31 is exposed on the top surface 3a of the projection 3, and forms the top surface 3a of the projection 3.

In the elastic crawler 1A according to the present embodiment, the resin member 31 includes a connecting portion 312 that couples the two base portions 311 with each other. The connecting portion 312 is embedded in the apex of the elastic projection 32. The connecting portion 312 includes a top surface 312a forming the top surface 3a of the projection 3. In other words, according to the present embodiment, the top surface 312a of the connecting portion 312 is exposed, as the other part of the resin member 31, on the top surface 3a of the projection 3 and forms the top surface 3a of the projection 3.

As illustrated in FIG. 4 and the like, in the elastic crawler 1A according to the present embodiment, the top surface 3a of the projection 3 includes the top surface 312a of the connecting portion 312 of the resin member 31 and a top surface 32a of the elastic projection 32. In the present embodiment, a step does not exist between the top surface 312a of the connecting portion 312 of the resin member 31 and the top surface 32a of the elastic projection 32, and the top surface 3a of the projection 3 is smoothly formed. In other words, the top surface 3a of the projection 3 is the same level surface (for example, the same flat surface) formed by the top surface 312a of the connecting portion 312 of the resin member 31 and the top surface 32a of the elastic projection 32.

When the elastic crawler 1A suddenly operates and the vehicle turns, the rotating body such as the track roller 130 rides on the crawler-circumferential-direction side surface 3b2 of the projection 3 of the elastic crawler 1A, thereby the rotating body may largely interfere with the top surface 3a of the projection of the elastic crawler 1A and affect the durability of the projection 3 of the elastic crawler 1A.

Therefore, as illustrated in FIG. 5, in the elastic crawler 1A according to the present embodiment, the top surface 312a of the connecting portion 312 of the resin member 31 is exposed, as the other part of the resin member 31, on the top surface 3a of the projection 3, and forms the top surface 3a of the projection 3. In this case, the resin member 31 protects the top surface 3a of the projection 3 of the elastic crawler 1A, so that the durability of the projection 3 can be further improved.

In the elastic crawler 1A according to the present embodiment, as illustrated in FIG. 5 and the like, the crawler-width-direction side surface 311b1 of the base portion 311 of the resin member 31 is connected to the top surface 312a of the connecting portion 312. In this case, as illustrated in FIG. 3 and the like, between the crawler-width-direction side surface 311b1 of the base portion 311 and the top surface 312a of the connecting portion 312, a crawler circumferential direction ridge 31L1 extending in the crawler circumferential direction is formed as a crawler-circumferential-direction end edge extending in the crawler circumferential direction of the projection 3. In this way, when at least one of the crawler-width-direction side surfaces 311b1 of the base portion 311 of the resin member 31 is connected to the top surface 312a of the connecting portion 312 to form the base portion 311 which is one rigid body, the durability of the projection 3 can be further improved. In particular, as in the present embodiment, when the top surface 312a of the connecting portion 312 of the resin member 31 is configured to connect the crawler-width-direction side surfaces 311b1 of the two base portions 311 arranged with a distance in the crawler width direction to each other, the durability of the projection 3 can be further improved.

In addition, as illustrated in FIG. 3, in the elastic crawler 1A according to the present embodiment, further another part of the resin member 31 is exposed on the crawler-circumferential-direction side surface 3b2 of the projection 3, and forms the crawler-circumferential-direction side surface 3b2 of the projection 3. In the elastic crawler 1A according to the present embodiment, each of the base portions 311 of the resin members 31 includes a crawler-circumferential-direction side surface 311b2 forming the crawler-circumferential-direction side surface 3b2 of the projection 3. In other words, according to the present embodiment, the crawler-circumferential-direction side surface 311b2 of the base portion 311 is exposed, as a part of the resin member 31, on the crawler-circumferential-direction side surface 3b2 of the projection 3, and forms the crawler-circumferential-direction side surface 3b2 of the projection 3.

In the present embodiment, the crawler-circumferential-direction side surface 3b2 of the projection 3 includes the crawler-circumferential-direction side surface 311b2 of the base portion 311 of the resin member 31 and a crawler-circumferential-direction side surface 32b2 of the elastic projection 32. In the present embodiment, the crawler-circumferential-direction side surface 311b2 of the base portion 311 of the resin member 31 and the crawler-circumferential-direction side surface 32b2 of the elastic projection 32 smoothly form the crawler-circumferential-direction side surface 3b2 of the projection 3 without a step therebetween. In other words, the crawler-circumferential-direction side surface 3b2 of the projection 3 is the same level surface (for example, the same flat surface) formed by the crawler-circumferential-direction side surface 311b2 of the base portion 311 of the resin member 31 and the crawler-circumferential-direction side surface 32b2 of the elastic projection 32.

For example, when the elastic crawler 1A suddenly operates or when the vehicle turns, the rotating body such as the track roller 130 rides on the crawler-circumferential-direction side surface 3b2 of the projection 3 of the elastic crawler 1A or the pin 110P of the drive wheel 110 contacts biasedly with the crawler-circumferential-direction side surface 3b2 of the projection 3 in the crawler width direction, thereby the rotating body largely interferes with the crawler-circumferential-direction side surface 3b2 of the projection 3 of the elastic crawler 1A or an excessive load is applied to the projection 3, which may affect the durability of the projection 3 of the elastic crawler 1A.

Therefore, in the elastic crawler 1A according to the present embodiment, the crawler-circumferential-direction side surface 311b2 of the base portion 311 is exposed, as further another part of the resin member 31, on the crawler-circumferential-direction side surface 3b2 of the projection 3, and forms the crawler-circumferential-direction side surface 3b2 of the projection 3. In this case, the resin member 31 protects the crawler-circumferential-direction side surface 3b2 of the projection 3 of the elastic crawler 1A, so that the durability of the projection 3 can be further improved.

In the elastic crawler 1A according to the present embodiment, the crawler-circumferential-direction side surface 311b2 of the base portion 311 of the resin member 31 is connected to the crawler-width-direction side surface 311b1. In this case, between the crawler-width-direction side surface 311b1 and the crawler-circumferential-direction side surface 311b2 of the base portion 311, a crawler thickness direction ridge 31L2 extending in the crawler thickness direction is formed as a crawler-thickness-direction end edge extending in the crawler thickness direction of the projection 3. In this way, when at least one of the crawler-width-direction side surfaces 311b1 of the base portion 311 of the resin member 31 is configured to connect the crawler-circumferential-direction side of at least one of crawler-width-direction side surfaces 311b1 with the crawler-circumferential-direction side surface 311b2 to form the base portion 311 which is one rigid body, the durability of the projection 3 can be further improved. In particular, as in the present embodiment, when each of the two crawler-width-direction side surfaces 311b1 of the base portion 311 of the resin member 31 is configured such that the crawler-circumferential-direction side surfaces 311b2 are connected to two crawler-circumferential-direction sides of the crawler-width-direction side surface 311b1, the durability of the projection 3 can be further improved.

Similarly, in the elastic crawler 1A according to the present embodiment, the crawler-circumferential-direction side surface 311b2 of the base portion 311 of the resin member 31 is connected to the top surface 312a. In this case, between the crawler-circumferential-direction side surface 311b2 of the base portion 311 and the top surface 312a, a crawler width direction ridge 31L3 extending in the crawler width direction is formed as a crawler-width-direction end edge extending in the crawler width direction of the projection 3. In this way, when the crawler inner circumferential side of at least one of the crawler-circumferential-direction side surfaces 311b2 out of at least one of the two base portions 311 of the resin member 31 is connected to the top surface 312a to form the base portion 311, which is one rigid body, and the connecting portion 312, the durability of the projection 3 can be further improved. In particular, as in the present embodiment, when each of the two base portions 311 of the resin member 31 is configured to connect the top surface 312a with the crawler inner circumferential sides of the two crawler-circumferential-direction side surface 311b2, the durability of the projection 3 can be further improved.

In the elastic crawler 1A according to the present embodiment, the resin member 31 includes the two base portions 311 arranged to face each other in the crawler width direction and one connecting portion 312 connecting the two base portions 311, and a region is partitioned between the base portion 311 and the connecting portion 312 to accommodate other portions forming the projection 3.

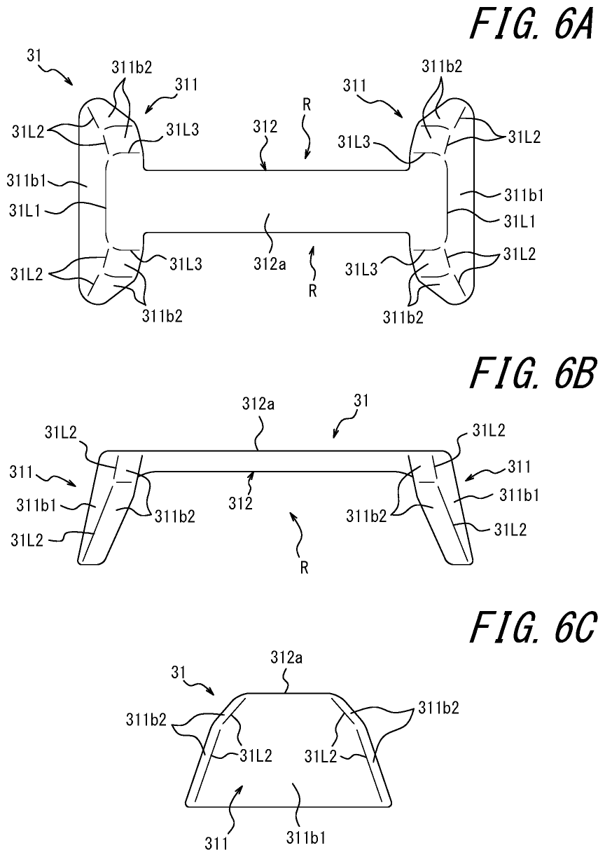

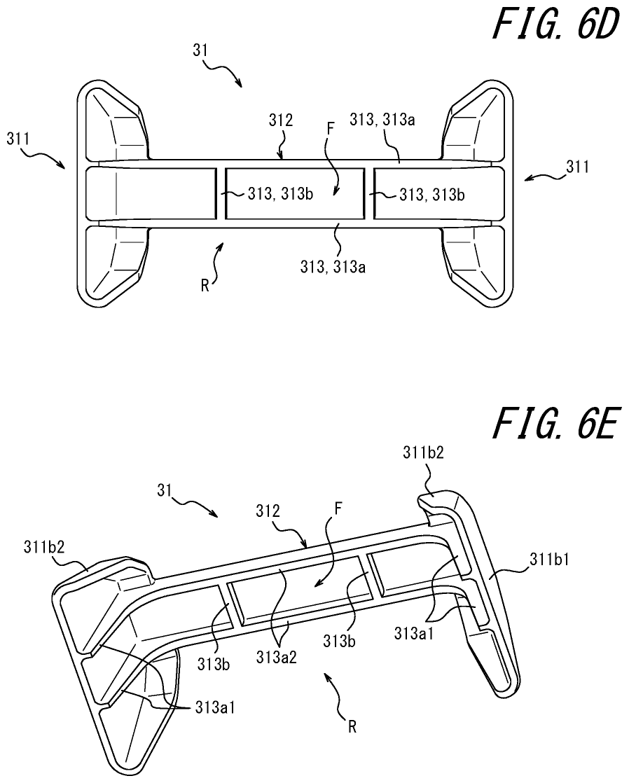

Each of FIGS. 6A to 6E illustrates the resin member 31 of the elastic crawler 1A according to the present embodiment. In the present embodiment, the resin member 31 is configured as a thin plate. In the present embodiment, the resin member 31 is integrally formed as one component by injection molding using a thermoplastic resin, for example. In the present embodiment, as illustrated in FIG. 6A, a length of the connecting portion 312 in the lateral direction (crawler circumferential direction) is shorter than a length of the crawler-width-direction side surface 311b1 of the base portion 311 in the extending direction. Further, the connecting portion 312 is connected to an upper end of the base portion 311. Thus, the resin member 31 is configured in which a region R is partitioned between the base portion 311 and the connecting portion 312 to accommodate (fill) the elastic projection 32 forming the projection 3.

Similarly to the elastic crawler 1A according to the present embodiment, when the two base portions 311 are connected to each other by the connecting portion 312 extending in the crawler width direction, the strength of the two base portions 311 is improved against a load in the crawler width direction. In the present embodiment, the region R is partitioned between the base portion 311 and the connecting portion 312 to accommodate the elastic projection 32 forming the projection 3. In this case, an embedded surface F of the resin member 31 in contact with the projection 3 is largely ensured, and thus an adhesion area between the resin member 31 and the elastic projection 32 is largely ensured. Thereby, according to the present embodiment, the durability of the projection 3 of the elastic crawler 1A and the durability of the elastic crawler 1A can be further improved.

In the elastic crawler 1A according to the present embodiment, the resin member 31 preferably includes at least one of a concave portion and a convex portion on the embedded surface in contact with the projection 3. In this case, the embedded surface of the resin member 31 in contact with the projection 3 is largely ensured and a bonding area between the projection 3 and the resin member 31 of the elastic crawler 1A is largely ensured.

Thereby, a bond force between the resin member 31 and the elastic projection 32 increases, and as a result, the durability of the projection 3 of the elastic crawler 1A and the durability of the elastic crawler 1A can be further improved.

In the elastic crawler 1A according to the present embodiment, as illustrated in FIG. 6D, the resin member 31 includes a convex portion 313 on the embedded surface F in contact with the projection 3. In the elastic crawler 1A according to the present embodiment, the convex portion 313 includes a first rib 313a and a second rib 313b. However, either of the first rib 313a and the second rib 313b may be provided.

In the elastic crawler 1A according to the present embodiment, the first rib 313a extends in the longitudinal direction (crawler width direction) of the connecting portion 312 of the resin member 31. Specifically, as illustrated in FIG. 6E, the first rib 313a includes a rib 313a1 extending in the base portion 311 in the height direction (crawler thickness direction) and a rib 313a2 extending in the connecting portion 312 in the longitudinal direction. As illustrated in FIG. 4, the first rib 313a is a rib that protrudes toward the elastic projection 32 and extends in the crawler width direction when the resin member 31 is formed as a part of the projection 3 of the elastic crawler 1A.

In the present embodiment, two first ribs 313a are arranged with a distance in the lateral direction (crawler circumferential direction) of the connecting portion 312 of the resin member 31. However, the number of the first ribs 313a may be at least one.

In the elastic crawler 1A according to the present embodiment, as illustrated in FIG. 6E, the second rib 313b extends in the lateral direction of the connecting portion 312 of the resin member 31. As illustrated in FIG. 5, the second rib 313b is a rib that protrudes toward the elastic projection 32 and extends in the crawler circumferential direction when the resin member 31 is formed as a part of the projection 3 of the elastic crawler 1A. In the present embodiment, two second ribs 313b are arranged with a distance in the longitudinal direction of the connecting portion 312 of the resin member 31. However, the number of the second ribs 313b may be at least one.

A convex portion may be provided on the embedded surface F of the resin member 31. Examples of the convex portion include a single convex portion, embossing, and surface texturing. For example, a convex portion 313 may be provided with the convex portion. When the convex portion is provided on the embedded surface F such as the convex portion 313 of the resin member 31, the adhesion between the resin member 31 and the elastic projection 32 becomes good. In particular, when the elastic projection 32 is made of rubber, the adhesion to the resin member 31 becomes good. On the other hand, the outer surface of the resin member 31 preferably has small frictional resistance in consideration of contact with the track roller 130 and the like. Therefore, it is preferable not to perform surface roughness processing, such as providing the convex portion, on the outer surface of the resin member 31.

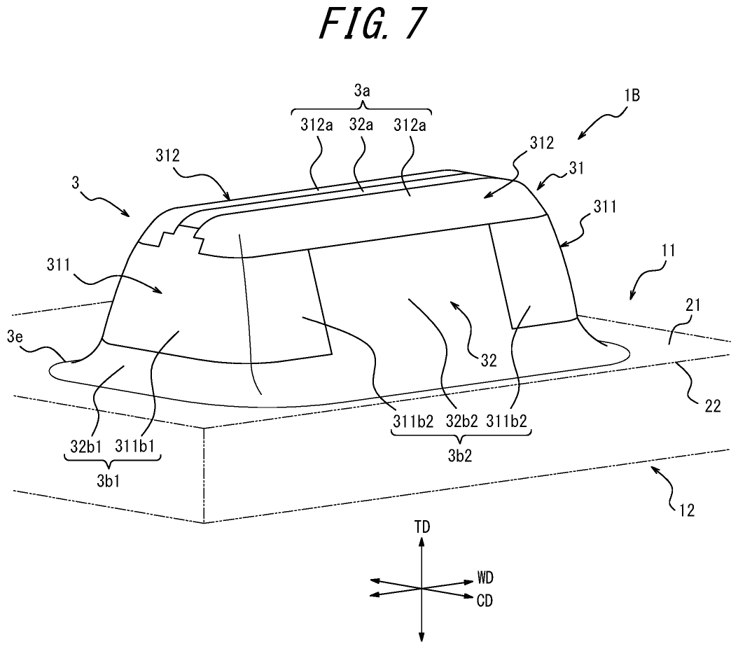

Next, FIG. 7 is an enlarged perspective view schematically illustrating a projection 3 of an elastic crawler 1B according to a second embodiment of the disclosure. Portions, which are substantially the same as those described above, will be denoted by the same reference numerals, and will not be described.

In the elastic crawler 1B according to the present embodiment, a top surface 3a of the projection 3 includes a top surface 312a of a connecting portion 312 of a resin member 31 and a top surface 32a of an elastic projection 32. In the present embodiment, two connecting portions 312 are arranged with a distance in the crawler circumferential direction. The top surface 32a of the elastic projection 32 is interposed between the top surfaces 312a of the two connecting portions 312. Similarly to the first embodiment, a step does not exist between the top surface 312a of the connecting portion 312 of the resin member 31 and the top surface 32a of the elastic projection 32, and a top surface 3a of the projection 3 is smoothly formed. In other words, also in the present embodiment, the top surface 3a of the projection 3 is the same level surface (for example, the same flat surface) formed by the top surface 312a of the connecting portion 312 of the resin member 31 and the top surface 32a of the elastic projection 32.

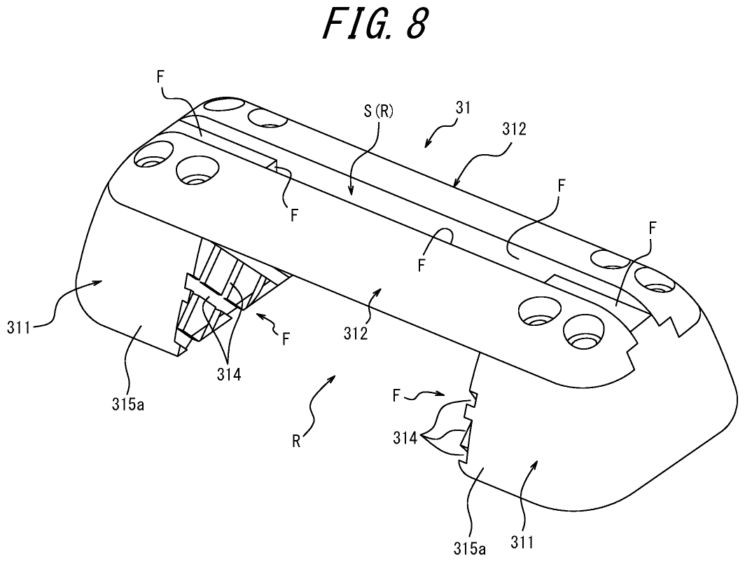

FIG. 8 is a plan perspective view schematically illustrating the resin member 31 forming a part of the projection 3 of the elastic crawler 1B according to the present embodiment. In the present embodiment, the resin member 31 includes two connecting portions that connect two base portions 311 to each other. In this case, since rigidity of the entire resin member 31 is improved, durability of the projection 3 of the elastic crawler 1B and durability of the elastic crawler 1B can be further improved. In the present embodiment, a space S is formed between the two connecting portions 312. In the present embodiment, not only the region R of the resin member 31 according to the first embodiment but also the space S functions as the region R, and the elastic projection 32 are partially accommodated inside the space S. In this case, an embedded surface F of the resin member 31 in contact with the projection 3 is largely ensured, and an adhesion area between the resin member 31 and the elastic projection 32 is largely ensured. Thus, adhesion durability between the resin member 31 and the elastic projection 32 is increased, and as a result, the durability of the projection 3 of the elastic crawler 1B can be improved, thereby the durability of the elastic crawler 1B can be improved.

In the elastic crawler 1B according to the present embodiment, the resin member 31 is formed by a combination of the base portion 311 and the connecting portion 312. Specifically, the resin member 31 includes two base portions 311 and two connecting portions 312, and the base portions 311 and the connecting portions 312 are formed as four separate components. The base portions 311 and the connecting portions 312 can be bonded using a fixing means such as adhesion or fastening. In the present embodiment, the base portions 311 and the connecting portions 312 are bonded using a fastening element such as a bolt. However, according to the present embodiment of the disclosure, the base portions 311 and the connecting portions 312 can be integrally molded as in the first embodiment. Alternatively, the base portions 311 and the connecting portions 312 according to the first embodiment can be assembled as individual components as in the present embodiment.

Further, also in the elastic crawler 1B according to the present embodiment, the resin member 31 preferably includes at least one of a concave portion and a convex portion on the embedded surface in contact with the projection 3.

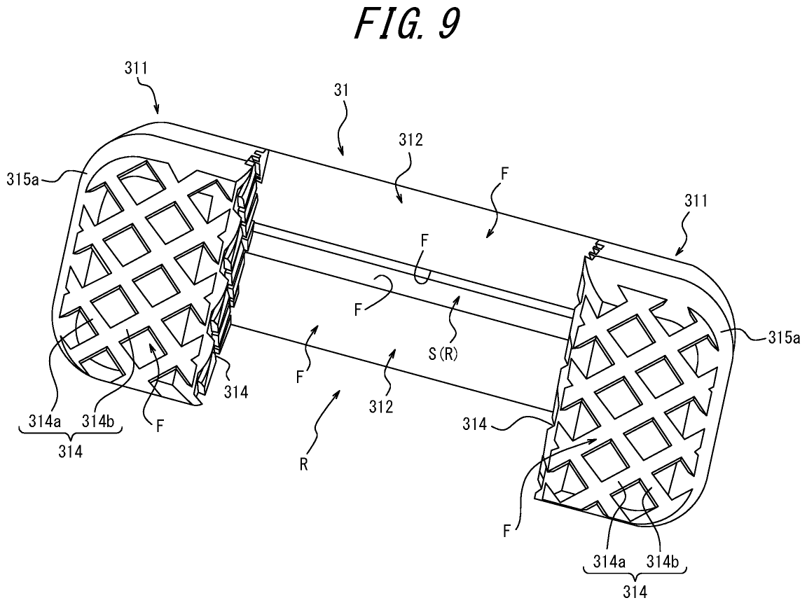

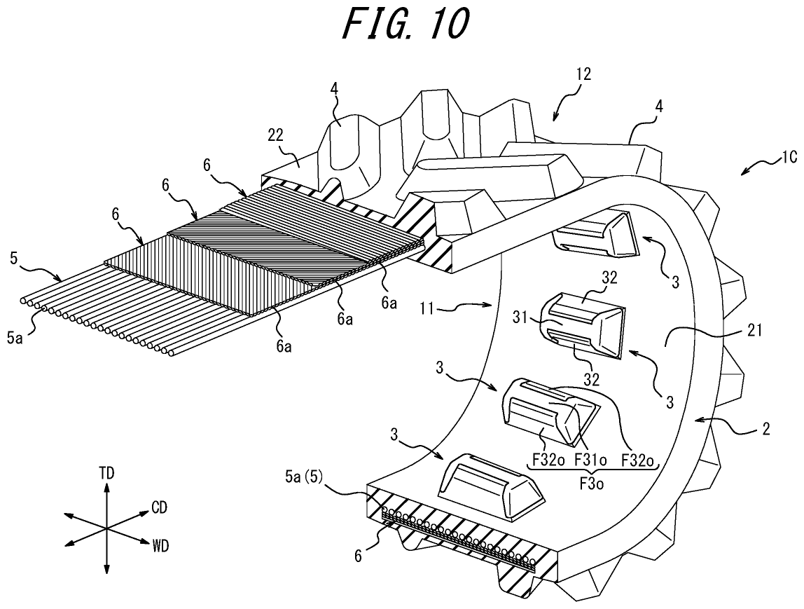

In the elastic crawler 1B according to the present embodiment, as illustrated in FIGS. 8 and 9, the resin member 31 includes a concave portion 314 on the embedded surface F in contact with the projection 3. In the present embodiment, the concave portion 314 includes a first groove 314a and a second groove 314b. In the present embodiment, as illustrated in FIG. 9, the first groove 314a and the second groove 314b have different inclination directions. Thus, according to the present embodiment, the concave portion 314 is formed as a plurality of lattice-like grooves. However, according to the disclosure, either of the first groove 314a and the second groove 314b may be provided. In addition, according to the disclosure, the number of concave portions 314 may be at least one.

Also in the elastic crawler 1B according to the present embodiment, the embedded surface F of the resin member 31 in contact with the projection 3 is largely ensured, and thus a bonding area between the resin member 31 and the elastic projection 32 is largely ensured. Thereby, a bond force between the resin member 31 and the elastic projection 32 is increased, and as a result, the durability of the projection 3 of the elastic crawler 1B can be improved, thereby the durability of the elastic crawler 1B can be improved.

According to the disclosure, the concave portion 314 is not limited to the groove shape as in the present embodiment. Examples of another concave portion 314 include a sealing hole (blind hole). Also in the elastic crawler 1B according to the present embodiment, a convex portion may be provided on the embedded surface F of the resin member 31. Examples of the convex portion include a single convex portion, embossing, and surface texturing. For example, the concave portion 314 may be provided with the convex portion. When the convex portion is provided on the embedded surface F such as the concave portion 314 of the resin member 31, the adhesion between the resin member 31 and the elastic projection 32 becomes good as in the elastic crawler 1A. In particular, when the elastic projection 32 is made of rubber, the adhesion to the resin member 31 becomes good. On the other hand, the outer surface of the resin member 31 preferably also has small frictional resistance in consideration of contact with the track roller 130 and the like as in the elastic crawler 1A. Therefore, also in the present embodiment, it is preferable not to perform that surface roughness processing, such as providing the convex portion, on the outer surface of the resin member 31, as in the elastic crawler 1A.

In the first and second embodiments, the resin member 31 integrally includes the crawler-width-direction side surface 311b1 of the base portion 311, the crawler-circumferential-direction side surface 311b2 of the base portion 311, and the top surface 312a of the connecting portion 312, but the respective portions can also be configured as outer surfaces of individual members. In addition, the connecting portion 312 is configured such that the top surface 312a of the connecting portion 312 forms the same outer surface as the crawler-width-direction side surface 311b1 and the crawler-circumferential-direction side surface 311b2 of the base portion 311, but may be incorporated in the elastic projection 32. In this case, the connecting portion 312 is not exposed to the top surface 32a of the elastic projection 32. Further, according to the disclosure, the crawler-circumferential-direction side surface 311b2 of the base portion 311 cannot be presented.

FIG. 10 is a perspective view illustrating a partial cross section of an elastic crawler 1C according to a third embodiment of the disclosure.

The elastic crawler 1C also includes a crawler body 2 which is formed in an endless belt shape and is made of an elastic material. In addition, the elastic crawler 1C also includes a plurality of projections 3 arranged with distances on an inner circumferential surface 21 of the crawler body 2.

As illustrated in FIG. 10, each of the plurality of projections 3 also protrudes from the inner circumferential surface 21 of the crawler body 2 toward a crawler inner circumferential side. Further, the plurality of projections 3 is also arranged with a regular distance from each other in the crawler circumferential direction. In the present embodiment, an inner circumferential surface 11 of the elastic crawler 1C is formed by the inner circumferential surface 21 of the crawler body 2 and outer surfaces F3o of the projections 3.

Further, the elastic crawler 1C according to the present embodiment also includes a plurality of lugs 4 arranged with a distance from each other on the outer circumferential surface 22 of the crawler body 2.

The elastic crawler 1C according to the present embodiment is a coreless rubber crawler as in the other embodiments. In the present embodiment, as illustrated in FIG. 10, each of the plurality of projections 3 is arranged at a center in the crawler width direction.

As illustrated in one projection 3 in FIG. 10, each of the plurality of projections 3 includes a resin member 31 and an elastic material portion 32. In the present embodiment, as illustrated in FIG. 10, the projection includes the resin member 31 and the elastic material portion 32.

In the present embodiment, the elastic material portion 32 is an elastic projection provided on the inner circumferential surface 21 of the crawler body 2 as in the other embodiments. The elastic material portion 32 has strength against contact with a pin 110P and absorbs an impact from the outside. In the present embodiment, the elastic material portion 32 protrudes, as a part of the projection 3, from the inner circumferential surface 21 of the crawler body 2 toward the crawler inner circumferential side. In the present embodiment, the elastic material portions 32 as the part of the projection 3 are arranged at a center in the crawler width direction with regular distances from each other in the crawler circumferential direction. The elastic material portion 32 is made of an elastic material. In this example, the elastic material is rubber, like the lug 4, as in the other embodiments.

The resin member 31 is a covering member that covers the elastic material portion 32 as in the other embodiments. As in the other embodiments, the resin member 31 prevents abrasion and breakage of the elastic material portion 32, and reinforces the elastic material portion 32. In the present embodiment, the resin member 31 is made of polyketone resin. In the present embodiment, the resin member 31 is embedded in the elastic material portion 32 as in the other embodiments. In the present embodiment, a part of the resin member 31 is exposed from the elastic material portion 32 as in the other embodiments. Reference numeral F31o indicates an outer surface of the resin member 31. Further, reference numeral F32o indicates an outer surface of the elastic material portion 32. In the present embodiment, the outer surface F3o of the projection 3 is formed by the outer surface F31o of the resin member 31 and the outer surface F32o of the elastic material portion 32. The rest of the elastic material portion 32 excluding the exposed part (outer surface F32o) of the elastic material portion 32 is embedded inside the resin member 31 as in the other embodiments. In the present embodiment, a step does not exist between the outer surface F31o of the resin member 31 and the outer surface F32o of the elastic material portion 32 and the outer surface F3o of the projection 3 is smoothly formed, as in the other embodiments. In other words, the outer surface F3o of the projection 3 is the same level surface (for example, the same flat surface) formed by the outer surface F31o of the resin member 31 and the outer surface F32o of the elastic material portion 32. However, a step may exist between the outer surface F31o of the resin member 31 and the outer surface F32o of the elastic material portion 32 as in the other embodiments. For example, when the outer surface F32o of the elastic material portion 32 protrudes outward from the outer surface F31o of the resin member 31, a step may arise on the outer surface F3o of the projection 3.

The projection 3 can be formed together with the elastic material portion 32 with, for example, unvulcanized rubber, using the resin member 31 as an insert article, as in the other embodiments. Further, the projection 3 can be formed in such a manner that the resin member 31 adheres to the elastic material portion 32, for example. In this case, the projection 3 can adhere to the crawler body 2 in a fashion of vulcanization. Further, the projection 3 can also be formed together with the elastic material portion 32 and the crawler body 2 with, for example, unvulcanized rubber, using the resin member 31 as an insert article. In other words, the projection 3 can be formed by chemical or physical bonding of the resin member 31 and the elastic material portion 32, as in the other embodiments.

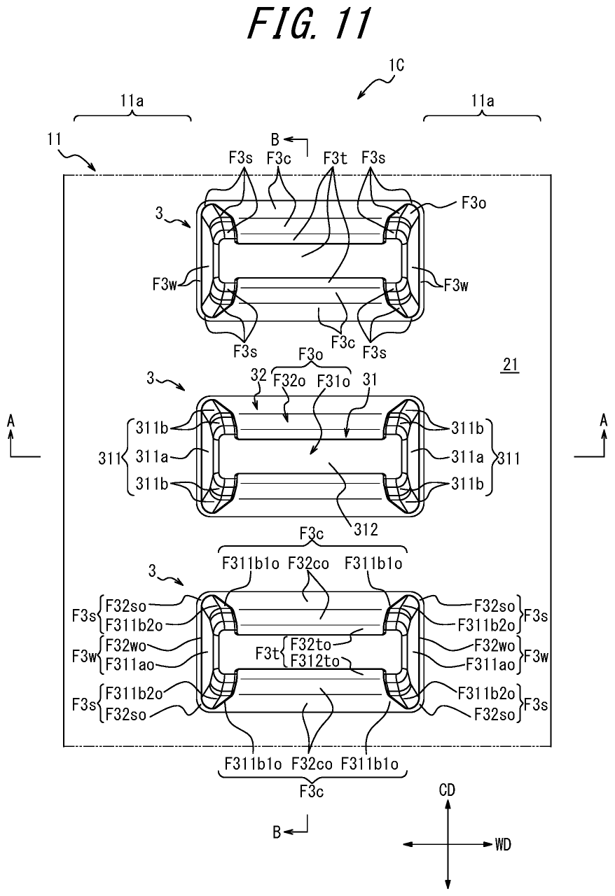

FIG. 11 illustrates a partially enlarged inner circumferential surface 11 of the elastic crawler 1C. In FIG. 11, three projections 3 are illustrated.

With reference to the projection 3 on an upper side in FIG. 11, the outer surface F3o of the projection 3 in the present embodiment is formed by a top surface F3t (hereinafter, also referred to as “projection-top surface F3t”) of the projection 3 and side surfaces (F3w, F3c, and F3s) of the projection 3 that surrounds the projection-top surface F3t. Out of the outer surface F3o of the projection 3, the projection-top surface F3t is located closer to the inner circumferential side in the crawler thickness direction than the inner circumferential surface 21 of the crawler body 2. In addition, the side surfaces of the projection 3 indicate the outer surface F3o of the projection 3 excluding the projection-top surface F3t. In the present embodiment, the side surfaces of the projection 3 include two crawler-width-direction side surfaces F3w arranged on both sides in the crawler width direction, two crawler-circumferential-direction side surfaces F3c arranged on both sides in the crawler circumferential direction, and four columnar corner surfaces F3s that is continuous with the crawler-width-direction side surfaces F3w of the projection 3 and the crawler-circumferential-direction side surfaces F3c of the projection 3.

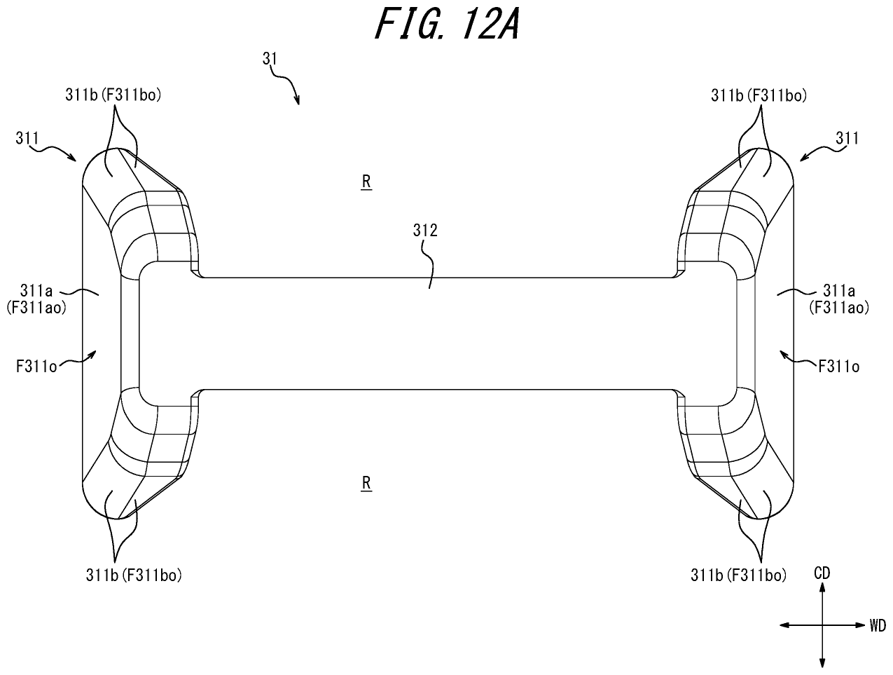

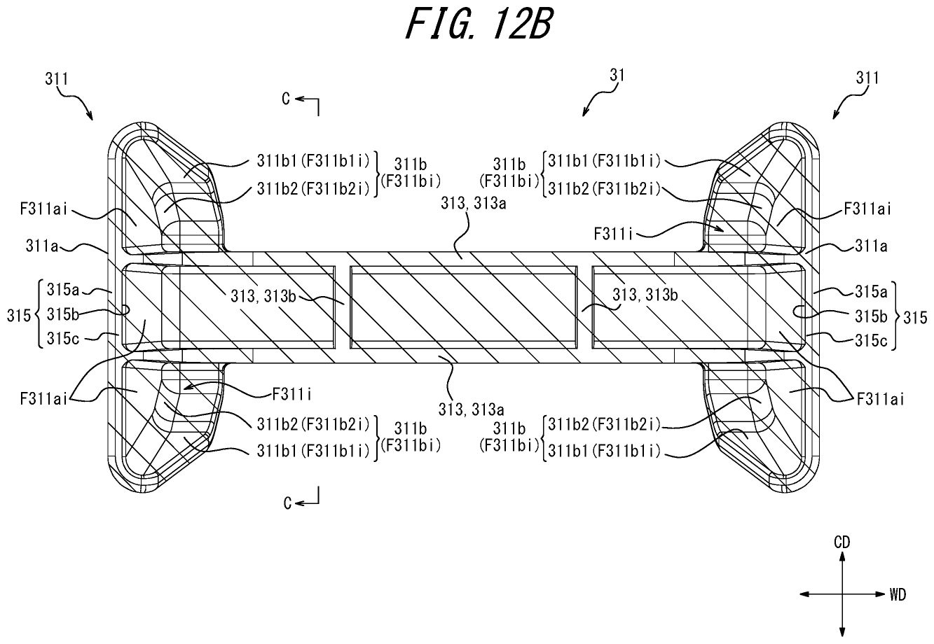

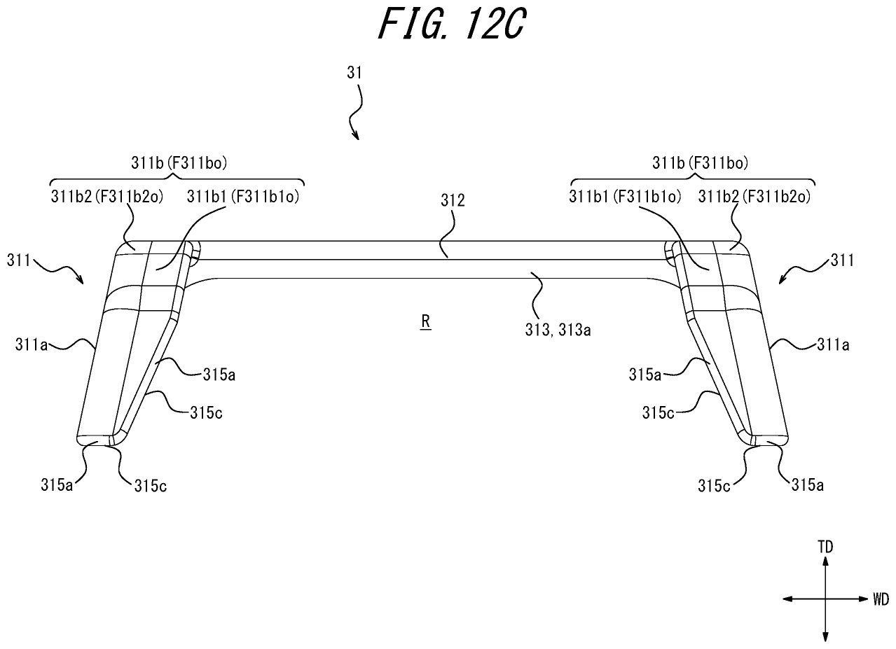

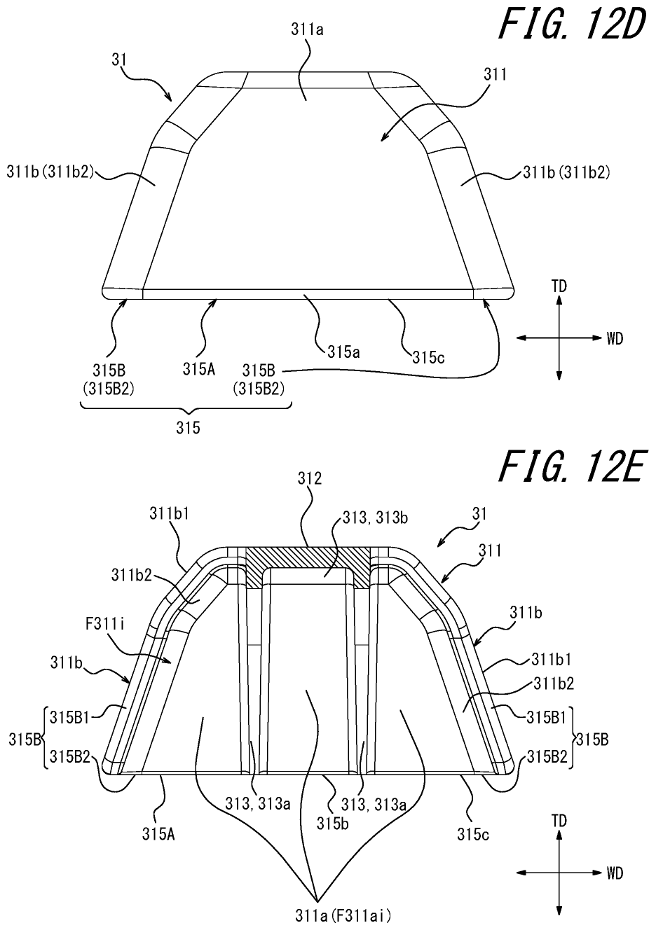

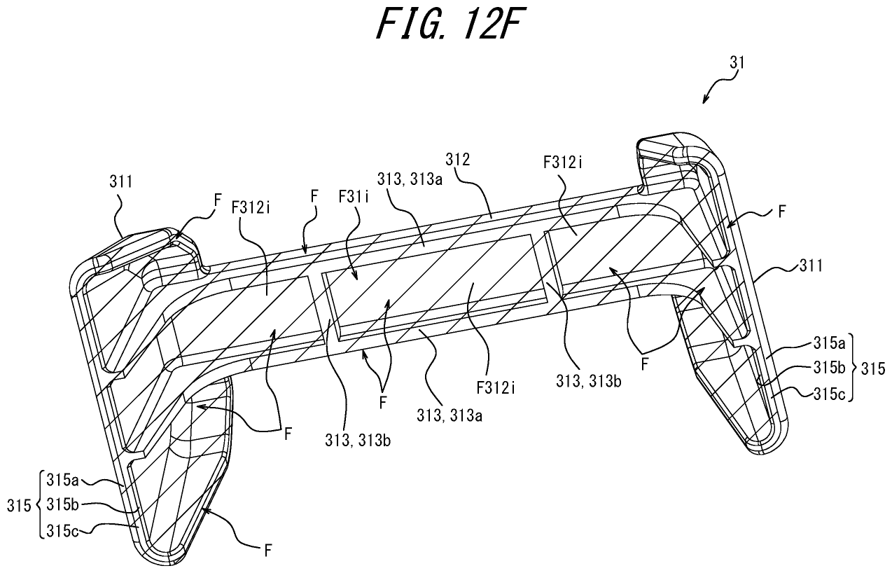

Here, FIG. 12A is a plan view schematically illustrating the resin member 31. FIG. 12B is a bottom view of the resin member 31. FIGS. 12C and 12D are a front view and a side view of the resin member 31, respectively. Further, FIG. 12E is a cross-sectional view taken along a line C-C in FIG. 12B.

Referring to FIG. 12A, the resin member 31 includes crawler-width-direction side surface portions (base portions) 311 as in the respective embodiments.

In the present embodiment, the resin member 31 includes two crawler-width-direction side surface portions 311 arranged in the crawler width direction to face each other, as in the respective embodiments. In the present embodiment, the resin member 31 includes at least one connecting portion 312 configured to connect the two crawler-width-direction side surface portions 311 to each other, as in the respective embodiment. In the present embodiment, the resin member 31 includes one connecting portion 312, as in the first embodiment. In other words, according to the present embodiment, the two crawler-width-direction side surface portions 311 are connected to each other by one connecting portion 312.

In the present embodiment, each of the two crawler-width-direction side surface portions 311 includes a crawler-circumferential-direction extending wall portion 311a extending in the crawler circumferential direction and a crawler-width-direction inward extending wall portion (wall portion) 311b extending inward in the crawler width direction. Therefore, according to the present embodiment, an outer surface F311o of the crawler-width-direction side surface portion 311 includes an outer surface F311ao of the crawler-circumferential-direction extending wall portion 311a and an outer surface F311bo of the crawler-width-direction inward extending wall portion 311b.

Specifically, as illustrated in FIG. 12B, each of the two crawler-width-direction side surface portions 311 is formed of a thin plate-shaped panel. In the present embodiment, one crawler-width-direction side surface portion 311 includes one crawler-circumferential-direction extending wall portion 311a and two crawler-width-direction inward extending wall portions 311b. In the present embodiment, the two crawler-width-direction inward extending wall portions 311b are connected to each other by one crawler-circumferential-direction extending wall portion 311a. Therefore, according to the present embodiment, an inner surface F311i of the crawler-width-direction side surface portion 311 includes an inner surface F311ai of the crawler-circumferential-direction extending wall portion 311a and an inner surface F311bi of the crawler-width-direction inward extending wall portion 311b.

More specifically, the crawler-width-direction inward extending wall portion 311b includes a crawler-width-direction extending wall portion 311b1 and a columnar corner wall portion 311b2 configured to connect the crawler-circumferential-direction extending wall portion 311a and the crawler-width-direction extending wall portion 311b1 to each other. In the present embodiment, as illustrated in FIG. 12B, the columnar corner wall portion 311b2 has a curved shape in a plan view. Thereby, the crawler-circumferential-direction extending wall portion 311a and the crawler-width-direction extending wall portion 311b1 are smoothly connected to each other by the columnar corner wall portion 311b2 as illustrated in FIG. 12B. In the present embodiment, reference numeral “311b1” is used in different meaning from the “crawler-width-direction side surface 311b1 of the base portion 311” described in the first embodiment.

In the present embodiment, as illustrated in FIG. 12B, the inner surface F311bi of the crawler-width-direction inward extending wall portion 311b includes an inner surface F311b1i of the crawler-width-direction extending wall portion 311b1 and an inner surface F311b2i of the columnar corner wall portion 311b2. In the present embodiment, as illustrated in FIG. 12C, the outer surface F311bo of the crawler-width-direction inward extending wall portion 311b includes an outer surface F311b1o of the crawler-width-direction extending wall portion 311b1 and an outer surface F311b2o of the columnar corner wall portion 311b2.

In the present embodiment, the columnar corner wall portion 311b2 is arranged to face outward in the crawler circumferential direction together with the crawler-width-direction extending wall portion 311b1 as illustrated in FIG. 12C, and is arranged to face outward in the crawler width direction together with the crawler-circumferential-direction extending wall portion 311a as illustrated in FIG. 12D.

In the present embodiment, as illustrated in FIG. 12E, the connecting portion 312 of the resin member 31 is connected to an upper end of the crawler-width-direction side surface portion 311. As illustrated in FIG. 12E, the connecting portion 312 is also formed of a thin plate-shaped panel. The connecting portion 312 is directly connected to the crawler-width-direction side surface portion 311, and is also indirectly connected to the crawler-width-direction side surface portion 311 through a first rib 313a. Also in the present embodiment, the resin member 31 includes two first ribs 313a as in the other embodiments. As in the other embodiments, the first rib 313a extends in the crawler width direction along the connecting portion 312, and is connected to the inner surface F311i of the crawler-width-direction side surface portion 311. Specifically, the first rib 313a is connected to the inner surface F311ai of the crawler-circumferential-direction extending wall portion 311a of the crawler-width-direction side surface portion 311 as in the other embodiments.

FIG. 12F is a perspective view of the resin member 31 as viewed from the bottom surface of the resin member 31. In the present embodiment, the resin member 31 also includes two first ribs 313a as in the other embodiments. Each of the two first ribs 313a is arranged at an outer end of the connecting portion 312 in the crawler circumferential direction. In the present embodiment, the resin member 31 also further includes a second rib 313b on the inner surface F312i of the connecting portion 312 as in the other embodiments. In the present embodiment, the second rib 313b also extends in the crawler circumferential direction as in the other embodiments. In the present embodiment, a plurality of second ribs 313b (two ribs in this example) is also arranged between the two first ribs 313a with a distance from each other in the crawler width direction as in the other embodiments. As in the other embodiments, the number of the first ribs 313a and the second ribs 313b may be any number. Further, either of the first rib 313a and the second rib 313b may be provided.

In addition, reference numeral 315 indicates an end edge of the crawler-width-direction side surface portion 311. The end edge 315 is a surface that forms an outline of the crawler-width-direction side surface portion 311. In the present embodiment, as will be described below, the end edge 315 of the crawler-width-direction side surface portion 311 forms a boundary surface BS between the elastic material portion 32 and the crawler-width-direction side surface portion 311 when the crawler-width-direction side surface portion 311 is embedded in the elastic material portion 32.

In the present embodiment, referring to FIG. 12D, the end edge 315 of the crawler-width-direction side surface portion 311 includes an end edge 315A that forms an outline of the crawler-circumferential-direction extending wall portion 311a and an end edge 315B that forms an outline of the crawler-width-direction inward extending wall portion 311b.

In the present embodiment, the end edge 315A of the crawler-circumferential-direction extending wall portion 311a is an end edge on the crawler-thickness-direction side (crawler-thickness-direction end edge) formed facing in the crawler thickness direction. In the present embodiment, the end edge 315A of the crawler-circumferential-direction extending wall portion 311a is an end edge (hereinafter, also referred to as “crawler-thickness-direction outer circumferential end edge 315A”) on the crawler-thickness-direction outer circumferential side.

In the present embodiment, referring to FIG. 12E, the end edge 315B of the crawler-width-direction inward extending wall portion 311b includes an end edge 315B1 of the crawler-width-direction extending wall portion 311b1 and an end edge 315B2 of the columnar corner wall portion 311b2. In the present embodiment, the end edge 315B1 of the crawler-width-direction extending wall portion 311b1 is an end edge on the crawler-width-direction side (crawler-width-direction end edge) formed inward in the crawler width direction. In other words, according to the present embodiment, the end edge 315B1 of the crawler-width-direction extending wall portion 311b1 is an inner end edge in the crawler width direction. In the present embodiment, the end edge 315B2 of the columnar corner wall portion 311b2 is an end edge on the crawler-thickness-direction side (crawler-thickness-direction end edge) formed facing in the crawler thickness direction. In the present embodiment, the end edge 315B2 of the columnar corner wall portion 311b2 is an end edge (hereinafter, also referred to as “crawler-thickness-direction outer circumferential end edge 315B2”) on the crawler-thickness-direction outer circumferential side.

In other words, the crawler-width-direction side surface portion 311 includes, as crawler-thickness-direction end edges, the crawler-thickness-direction outer circumferential end edges 315A and 315B2.

In the present embodiment, referring to the projection 3 on the upper side and the projection 3 in the center in FIG. 11, the crawler-width-direction side surface F3w of the projection 3 includes the elastic material portion 32 and the crawler-width-direction side surface portion 311 of the resin member 31. In the present embodiment, the crawler-circumferential-direction side surface F3c of the projection 3 includes the elastic material portion 32. In the present embodiment, the columnar corner surface F3s of the projection 3 includes the elastic material portion 32 and the crawler-width-direction side surface portion 311 of the resin member 31. In the present embodiment, the top surface F3t of the projection 3 includes the elastic material portion 32 and the connecting portion 312 of the resin member 31.

In the present embodiment, more specifically, referring to the projection 3 on the lower side in FIG. 11, the crawler-width-direction side surface F3w of the projection 3 includes the outer surface F311ao of the crawler-circumferential-direction extending wall portion 311a in the crawler-width-direction side surface portion 311 of the resin member 31 and a crawler-width-direction side surface F32wo of the elastic material portion 32 connected to the crawler outer surface F311ao. In the present embodiment, the crawler-circumferential-direction side surface F3c of the projection 3 includes the outer surface F311b1o of the crawler-width-direction extending wall portion 311b1 in the crawler-width-direction side surface portion 311 of the resin member 31 and a crawler-circumferential-direction side surface F32co of the elastic material portion 32 connected to the outer surface F311b1o. In the present embodiment, the columnar corner surface F3s of the projection 3 includes the outer surface F311b2o of the columnar corner wall portion 311b2 in the crawler-width-direction side surface portion 311 of the resin member 31 and a columnar corner surface F32so of the elastic material portion 32 connected to the outer surface F311b2o. In the present embodiment, the top surface F3t of the projection 3 includes an outer surface F313to of the connecting portion 312 of the resin member 31 and a top surface F32to of the elastic material portion 32 connected to the outer surface F313to.

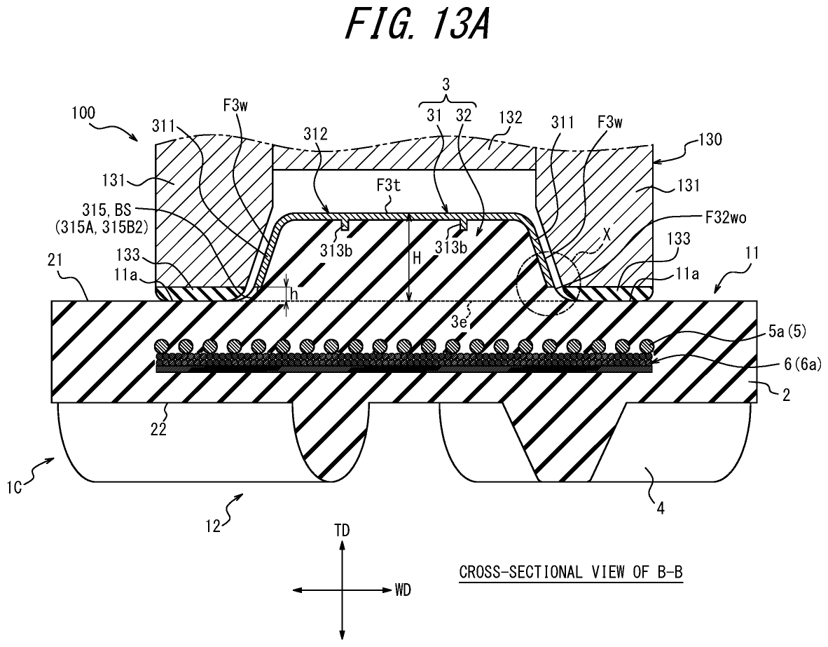

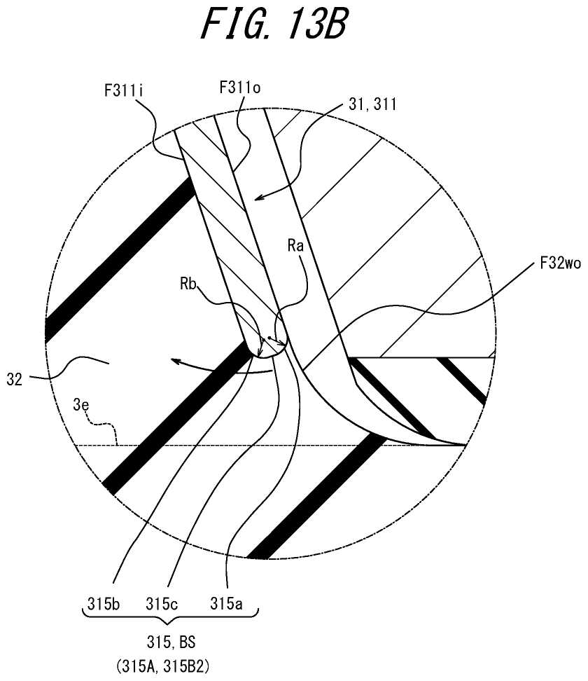

Here, FIG. 13A is a cross-sectional view taken along a line A-A in FIG. 11. In FIG. 13A, the elastic crawler 1C is illustrated in a cross section (crawler-width-direction cross section) illustrated in the crawler width direction (hereinafter, also referred to as “crawler-width-direction cross section view”). Further, FIG. 13B is an enlarged cross-sectional view of a region X in FIG. 13A.

As illustrated in FIG. 13A, the crawler-width-direction side surface portion 311 includes the crawler-thickness-direction outer circumferential end edge 315A (also including the crawler-thickness-direction outer circumferential end edge 315B2 in the present embodiment) forming the boundary surface BS with the elastic material portion 32.

In the present embodiment, as illustrated in FIG. 13B, the crawler-thickness-direction outer circumferential end edge 315A includes, in the crawler-width-direction cross section view as illustrated in FIG. 13B, a crawler-width-direction outer corner portion 315a that is continuous with the outer surface F311o of the crawler-width-direction side surface portion 311, a crawler-width-direction inner corner portion 315b that is continuous with the inner surface F311i of the crawler-width-direction side surface portion 311, and an intermediate portion 315c that is continuous with the crawler-width-direction outer corner portion 315a and the crawler-width-direction inner corner portion 315b.

As illustrated in FIG. 13B, the crawler-width-direction outer corner portion 315a of the crawler-thickness-direction outer circumferential end edge 315A has a rounded shape (fillet) from the outer surface F311o of the crawler-width-direction side surface portion 311 toward the inner surface F311i of the crawler-width-direction side surface portion 311 in a crawler-thickness-direction cross section view.

In the present embodiment, as illustrated in FIG. 13B, the crawler-width-direction outer corner portion 315a of the crawler-thickness-direction outer circumferential end edge 315A is outlined by a circular arc having a radius of curvature Ra in the crawler-width-direction cross section view. In the present embodiment, as described above, the fillet having a radius of curvature Ra is affixed to the crawler-width-direction outer corner portion 315a of the crawler-thickness-direction outer circumferential end edge 315A along the extending direction of the crawler-thickness-direction outer circumferential end edge 315A. The fillet can be formed by R chamfering, for example.

In the present embodiment, as illustrated in FIG. 13B, the crawler-thickness-direction outer circumferential end edge 315A of the crawler-width-direction side surface portion 311 includes a flat portion that is continuous with the crawler-width-direction outer corner portion 315a and extends flatly toward the inner surface F311i of the crawler-width-direction side surface portion 311 in the crawler-width-direction cross section view.

In the present embodiment, the flat portion is the intermediate portion 315c of the crawler-thickness-direction outer circumferential end edge 315A of the crawler-width-direction side surface portion 311.

In the present embodiment, as illustrated in FIG. 13B, the crawler-width-direction inner corner portion 315b of the crawler-thickness-direction outer circumferential end edge 315A of the crawler-width-direction side surface portion 311 is formed by a rounded shape (fillet) from the inner surface F311i of the crawler-width-direction side surface portion 311 toward the outer surface F311o of the crawler-width-direction side surface portion 311 in the crawler-width-direction cross section view. In the present embodiment, as illustrated in FIG. 13B, the crawler-width-direction inner corner portion 315b of the crawler-thickness-direction outer circumferential end edge 315A of the crawler-width-direction side surface portion 311 is outlined by a circular arc having a radius of curvature Rb in the crawler-width-direction cross section view. In the present embodiment, as described above, the fillet having the radius of curvature Rb is affixed to the crawler-width-direction inner corner portion 315b of the crawler-thickness-direction outer circumferential end edge 315A along the extending direction of the crawler-thickness-direction outer circumferential end edge 315A. The fillet can also be formed by R chamfering, for example. The radius of curvature Ra is preferably set to be larger than the radius of curvature Rb. In the present embodiment, the radius of curvature Ra is set to be larger than the radius of curvature Rb. However, according to the disclosure, the radius of curvature Ra can be set to be equal to the radius of curvature Rb or to be smaller than the radius of curvature Rb.

As illustrated in FIG. 13A, the elastic crawler 1C according to the present embodiment is also configured to pass over the track roller 130 during running as in the other embodiments. Also in this example, the projections 3 of the elastic crawler 1C are configured to be arranged inside the two track roller bodies 131 in the crawler width direction. Therefore, the projection 3 has a function of guiding the track roller 130 in the crawler width direction by the projection-width-direction side surface F3w as in the other embodiments. Thus, derailing of the elastic crawler 1C is prevented.

In the present embodiment as in the other embodiments, when the crawler-width-direction side surface portion 311 is exposed to the crawler-width-direction side surface F32wo of the elastic material portion 32 as a part of the resin member 31 to form the crawler-width-direction side surface F3w of the projection 3, the projection 3 can be protected by the crawler-width-direction side surface portion 311 of the resin member 31.

Further, the resin member 31 is formed of a resin material having a coefficient of friction lower than that of rubber, as in the other embodiments. For this reason, also in the present embodiment, when the projection 3 is formed by the resin member 31 and the elastic material portion 32 as in the other embodiments, the rotating body slips down, and thus the derailing of the elastic crawler 1C hardly occurs even when the rotating body such as the track roller 130 tries to ride on the projection 3.

On the other hand, when the projection 3 is formed by the resin member 31 and the elastic material portion 32 as in the respective embodiments described above, the boundary surface BS formed between the resin member 31 and the elastic material portion 32 is used as a base point, and differences in rigidity occurs due to differences in material. Therefore, when strain is concentrated on the boundary surface BS between the resin member 31 and the elastic material portion 32 or in the vicinity of the boundary surface BS, cracks may occur in the elastic material portion 32.

On the other hand, in the present embodiment, referring to FIG. 13B, the crawler-width-direction outer corner portion 315a of the crawler-thickness-direction outer circumferential end edge 315A has the rounded shape from the outer surface F311o toward the inner surface F311i of the crawler-width-direction side surface portion 311 in the crawler-width-direction side surface portion 311 of the resin member 31. In the present embodiment, the boundary surface BS between the resin member 31 and the elastic material portion 32 is chamfered to have the rounded shape. In this case, even when a large load is applied to the crawler-width-direction side surface portion 311 of the resin member 31 toward the inside in the crawler width direction, strain in a direction toward in the inside in the crawler width direction is not concentrated on the boundary surface BS between the resin member 31 and the elastic material portion 32 or in the vicinity of the boundary surface BS, in particular, on the boundary surface BS between the crawler-width-direction outer corner portion 315a of the crawler-thickness-direction outer circumferential end edge 315A of the crawler-width-direction side surface portion 311 and the elastic material portion 32 or in the vicinity of such a boundary surface BS, and the generation of strain is reduced on the boundary surface BS between the crawler-width-direction outer corner portion 315a and the elastic material portion 32 or in the vicinity of the boundary surface BS. Therefore, according to the present embodiment, the occurrence of cracks inward in the crawler width direction is prevented from the boundary surface BS between the elastic material portion 32 and the crawler-thickness-direction outer circumferential end edge 315A of the crawler-width-direction side surface portion 311 of the resin member 31 or from the vicinity of the boundary surface BS. In this case, as indicated by an arrow in FIG. 13B, a direction of a shearing force generated in the elastic material portion 32 is a direction in which the resin member 31 wraps around the inside of the crawler-width-direction side surface portion 311 along the rounded shape forming the crawler-width-direction outer corner portion 315a of the crawler-thickness-direction outer circumferential end edge 315A. Therefore, according to the present embodiment, even when cracks occur inward in the crawler width direction, the growth of the cracks is prevented.

In the present embodiment, the intermediate portion 315c of the crawler-thickness-direction outer circumferential end edge 315A is a flat portion that is continuous with the crawler-width-direction outer corner portion 315a and extends flatly toward the inner surface F311i of the crawler-width-direction side surface portion 311 in the crawler-width-direction cross section view. In this case, due to the existence of the flat portion between the crawler-width-direction outer corner portion 315a and the crawler-width-direction inner corner portion 315b of the crawler-thickness-direction outer circumferential end edge 315A, the occurrence and growth of cracks are further prevented, and thus the durability is further is improved.

In the present embodiment, the crawler-width-direction inner corner portion 315b of the crawler-thickness-direction outer circumferential end edge 315A in the crawler-width-direction side surface portion 311 of the resin member 31 has the rounded shape from the inner surface F311i toward the outer surface F311o of the crawler-width-direction side surface portion 311 in the crawler-width-direction cross section view. In this case, the occurrence and growth of cracks are further prevented, and thus the durability is further is improved as compared with a case where the crawler-width-direction inner corner portion 315b of the crawler-thickness-direction outer circumferential end edge 315A of the crawler-width-direction side surface portion 311 is not formed by the rounded shape.

In the present embodiment, as illustrated in FIGS. 13A and 13B, also in the crawler-thickness-direction outer circumferential end edge 315B2 of the crawler-width-direction inward extending wall portion 311b in the crawler-width-direction side surface portion 311 of the resin member 31, the crawler-width-direction outer corner portion 315a and the crawler-width-direction inner corner portion 315b have a rounded shape (fillet), and the intermediate portion 315c is a flat portion.

In the present embodiment, the crawler-width-direction side surface portion 311 of the resin member 31 is connected to the crawler-thickness-direction inner circumferential side (upper side) through the connecting portion 312 in a cantilever state. In this case, crawler-width-direction side surface portion 311 of the resin member 31 easily moves with respect to the connecting portion 312 with the crawler-thickness-direction inner circumferential side as a base point. Therefore, strain is easily concentrated on the boundary surface BS between the crawler-thickness-direction outer circumferential end edges 315A and 315B2 of the crawler-width-direction side surface portion 311 of the resin member 31 and the elastic material portion 32 in the projection 3 or in the vicinity of the boundary surface BS due to the contact of the track roller 130.

On the other hand, in the present embodiment, since either of the crawler-thickness-direction outer circumferential end edges 315A and 315B2 of the resin member 31 is configured in which the crawler-width-direction outer corner portion 315a and the crawler-width-direction inner corner portion 315b have the rounded shape (fillet) and the intermediate portion 315c is the flat portion, the occurrence and growth of cracks are further prevented, and thus the durability is further is improved.

In the present embodiment, the crawler-width-direction side surface portion 311 of the resin member 31 includes the crawler-width-direction inward extending wall portion (wall portion) 311b extending inward in the crawler width direction. In this case, since the crawler-width-direction side surface portion 311 of the resin member 31 is improved in strength, the occurrence and growth of cracks are further prevented, and thus the durability is further is improved.

In the present embodiment, the crawler-width-direction side surface portion 311 of the resin member 31 is also exposed on the crawler-width-direction side surface F32wo of the elastic material portion 32 as in the other embodiments. In this case, since the crawler-width-direction side surface portion 311 of the resin member 31 protects the elastic material portion 32, abrasion and deformation of the projection 3 are prevented, and thus the durability is further improved.

In the present embodiment, the resin member 31 also includes two crawler-width-direction side surface portions 311 arranged to face each other in the crawler width direction and at least one connecting portion 312 connecting the two crawler-width-direction side surface portions 311 as in the other embodiments. Also in the present embodiment, portions of the projection 3 excluding the two crawler-width-direction side surface portions 311 and the connecting portion 312 are formed by the elastic material portion 32 as in the other embodiments. Also in this case, since the two crawler-width-direction side surface portions 311 in the resin member 31 are connected, as one rigid body, to each other by the connecting portion 312 as in the other embodiments, the rigidity of the entire resin member 31 is improved, and thus the durability is further improved. Also in this case, the portions of the projection 3 excluding the two crawler-width-direction side surface portions 311 and the connecting portion 312 in the resin member 31 are formed by the elastic material portion 32 as in the other embodiments, the bonding area between the resin member 31 and the elastic material portion 32 is largely ensured, and thus the resin member 31 and the elastic material portion 32 are more firmly bonded. Therefore, also in this case, the durability of the entire projection 3 is improved, and thus the durability is further improved as in the other embodiments.

Incidentally, also in the present embodiment, the resin member 31 is configured as a thin plate as in the other embodiments. Also in the present embodiment, the resin member 31 is integrally formed as one component by injection molding using a thermoplastic resin. Also in the present embodiment, as illustrated in FIG. 12A, a length of the connecting portion 312 of the resin member 31 in the crawler circumferential direction is shorter than a length of the crawler-width-direction side surface portion 311 of the resin member 31 in the crawler circumferential direction. Also in the present embodiment, the connecting portion 312 of the resin member 31 is connected to the upper end of the crawler-width-direction side surface portion 311 of the resin member 31 as in the other embodiments. Thereby, also in the present embodiment, the resin member 31 is configured in which a region R is partitioned between the crawler-width-direction side surface portion 311 and the connecting portion 312 to accommodate (fill) the elastic material portion 32 forming the projection 3 as in the other embodiments. In this case, an embedded surface F (see FIG. 12F) of the resin member 31 in contact with the elastic material portion 32 is largely ensured, and thus an adhesion area between the resin member 31 and the elastic material portion 32 is largely ensured. Thereby, according to the present embodiment, the durability of the projection 3 and the durability of the elastic crawler 1C can be further improved.

Also in the present embodiment, the resin member 31 preferably includes at least one of a concave portion and a convex portion on the portion in contact with the elastic material portion 32 in other words, the embedded surface F as in the other embodiments. In this case, the embedded surface F of the resin member 31 in contact with the elastic material portion 32 is largely ensured and a bonding area between the resin member 31 and the elastic material portion 32 is largely ensured. Thereby, a bond force between the resin member 31 and the elastic material portion 32 increases, and as a result, the durability of the projection 3 and the durability of the elastic crawler 1C can be further improved.

Also in the present embodiment, as illustrated in FIG. 12F, a portion of the resin member 31 in contact with the elastic material portion 32 is configured as an embedded surface F as in the other embodiments. In the present embodiment, the embedded surface F of the resin member 31 is configured by the inner surface F31i of the resin member 31 and the end edge 315 of the crawler-width-direction side surface portion 311 of the resin member 31 other than the outer surface F31o of the resin member 31. Also in the present embodiment, the first rib 313a and the second rib 313b form a part of the embedded surface F as in the other embodiment.

Also in the present embodiment, other concave portions or convex portions may be provided on the embedded surface F of the resin member 31 as in the other embodiments. Examples of the other convex portions or convex portions may include a single convex portion, embossing, and surface texturing as in the other embodiments. For example, also in the present embodiment, as indicated by a hatch in FIG. 12F, other concave portions or convex portions such as embossing may be further provided on the entire embedded surface F. Also in this case, the adhesion between the resin member 31 and the elastic material portion 32 becomes good as in the other embodiments. In particular, even when the elastic material portion 32 is made of rubber, the adhesion to the resin member 31 becomes good as in the other embodiments. On the other hand, also in the present embodiment, the outer surface F31o of the resin member 31 preferably has small frictional resistance in consideration of contact with the track roller 130 and the like as in the other embodiments. Therefore, also in the present embodiment, it is preferable not to perform surface roughness processing, such as providing the convex portion, on the outer surface F31o of the resin member 31.

In the present embodiment, as illustrated in FIG. 13B, the crawler-thickness-direction end edge 315 of the crawler-width-direction side surface portion 311 is the crawler-thickness-direction outer circumferential end edge 315A or 315B2 arranged on the outer circumferential side of the crawler. Also in the present embodiment, as in the other embodiments, the crawler-thickness-direction outer circumferential end edge 315A or 315B2 of the crawler-width-direction side surface portion 311 is arranged on the crawler-thickness-direction inner circumferential side from a crawler-thickness-direction outer circumferential end 3e of the projection 3.

Referring to FIG. 13A, also in the present embodiment, a height H of the projection 3 is a height in the crawler thickness direction as in the other embodiments. In other words, according to the present embodiment, the height H of the projection 3 is a height from the crawler-thickness-direction outer circumferential end 3e of the projection 3 to the top surface F3t of the projection 3. According to the present embodiment, in the crawler-thickness-direction end edge 315 of the crawler-width-direction side surface portion 311 of the resin member 31, the end edges 315 closest to the crawler-thickness-direction outer circumferential side are the crawler-thickness-direction outer circumferential end edge 315A of the crawler-circumferential-direction extending wall portion 311a of the crawler-width-direction side surface portion 311 and the crawler-thickness-direction outer circumferential end edge 315B2 of the columnar corner wall portion 311b2 in the crawler-width-direction inward extending wall portion 311b. In other words, according to the present embodiment, the crawler-thickness-direction outer circumferential end edges 315A and 315B2 of the crawler-width-direction side surface portion 311 are lowermost ends of the crawler-width-direction side surface portion 311 of the resin member 31. In the present embodiment, the crawler-thickness-direction outer circumferential end edges 315A and 315B2 of the crawler-width-direction side surface portion 311 are located at a height h (>0) from the crawler-thickness-direction outer circumferential end 3e of the projection 3. The height h is a height in the crawler thickness direction as in the other embodiments. The height h can also be appropriately set according to various requirements such as dimensions, shapes, and required performance of the elastic crawler 1C as in the other embodiments. For example, in the present embodiment, the height h is set higher than a thickness of the rubber portion 133 in the crawler thickness direction so as to prevent direct contact of the resin member 31 with the rubber portion 133 (see FIG. 13A) of the track roller 130 on which the elastic crawler 1C can be mounted.

In the present embodiment, the resin member 31 is embedded in the elastic material portion 32 such that the crawler-thickness-direction outer circumferential end edges 315A and 315B2 of the crawler-width-direction side surface portion 311 of the resin member 31 are arranged on the crawler-thickness-direction inner circumferential side (upper side) from the crawler-thickness-direction outer circumferential end 3e of the projection 3. Also in this case, since the crawler-thickness-direction outer circumferential end 3e of the projection 3 is originally a portion where the strain is easily concentrated on due to the contact with the track roller 130 as in the other embodiments, when the crawler-thickness-direction outer circumferential end edges 315A and 315B2 of the crawler-width-direction side surface portion 311 of the resin member 31 reach the crawler-thickness-direction outer circumferential end 3e of the projection 3, the strain generated in the vicinity of the crawler-thickness-direction outer circumferential end 3e of the projection 3 is further increased due to the difference in rigidity generated in the boundary surface BS between the resin member 31 and the elastic material portion 32, but the generation of strain in the vicinity of the crawler-thickness-direction outer circumferential end 3e of the projection 3 is prevented, the occurrence and growth of cracks are further prevented, and thus the durability is further improved when the crawler-thickness-direction outer circumferential end edges 315A and 315B2 of the crawler-width-direction side surface portion 311 of the resin member 31 are located at the position higher than the crawler-thickness-direction outer circumferential end 3e of the projection 3 and the crawler-width-direction outer corner portion 315a in the crawler-thickness-direction outer circumferential end edges 315A and 315B2 of the crawler-width-direction side surface portion 311 of the resin member 31 is formed by a fillet.

As illustrated in FIGS. 8 and 9, the elastic crawler 1B according to the second embodiment described above also includes the crawler-width-direction side surface portion 311 of the resin member 31 in which the crawler-thickness-direction outer circumferential end edge 315A of the crawler-width-direction side surface portion 311 is formed by a fillet.

Also in the third embodiment, a part of the resin member 31, a part of other parts or the like can be separated. In the present embodiment, the resin member 31 integrally includes the crawler-width-direction side surface portion 311 and the connecting portion 312 of the resin member 31, but the respective portions can also be configured as individual members. For example, the resin member 31 can be configured only by the crawler-width-direction side surface portion 311. In this case, at least one of the end surface on the crawler-thickness-direction outer circumferential side and the crawler-thickness-direction inner circumferential side (upper side) in the end edge 315 of the crawler-width-direction side surface portion 311 of the resin member 31 can be formed in the above-described shape (fillet). In addition, the connecting portion 312 of the resin member 31 may be incorporated in the elastic material portion 32. In this case, the connecting portion 312 of the resin member 31 is not exposed to the elastic material portion 32. Further, according to the disclosure, the crawler-width-direction inward extending wall portion 311b of the crawler-width-direction side surface portion 311 of the resin member 31 may not be provided.

Only some embodiments of the disclosure are merely described, and various modifications can be made according to claims. In the present embodiment, for example, as illustrated in FIG. 12F, the crawler-width-direction outer corner portion 315a and the crawler-width-direction inner corner portion 315b have the rounded shape (fillet) and the intermediate portion 315c is the flat portion in the entire end edge 315 of the crawler-width-direction side surface portion 311 of the resin member 31, but at least only the crawler-thickness-direction outer circumferential end edges 315A and 315B2 of the crawler-width-direction side surface portion 315 of the resin member 31 excluding the end edge 315B1 of the crawler-width-direction extending wall portion 311b1 can be rounded. Further, according to the disclosure, in the crawler-width-direction side surface portion 311 of the resin member 31, the crawler-width-direction side surface portion 311 may include only the crawler-circumferential-direction extending wall portion 311a without the crawler-width-direction inward extending wall portion 311b. According to the disclosure, the resin member 31 may be configured only by the crawler-width-direction side surface portion 311. In this case, at least one of the end edge on the crawler-thickness-direction outer circumferential side and the crawler-thickness-direction inner circumferential side (upper side) in the end edge 315 of the crawler-width-direction side surface portion 311 of the resin member 31 may be formed in the above-described shape.

A part of the resin member 31, a part of other parts or the like can be separated. Various configurations adopted in the respective embodiments can be used in combination with each other. Further, various configurations adopted in the respective embodiments can be appropriately replaced with each other.

### REFERENCE SIGNS LIST

1A elastic crawler (first embodiment)

1B elastic crawler (second embodiment)

1C elastic crawler (third embodiment)

2 crawler body

3 projection

3a top surface of projection

3b side surface of projection

3b1 crawler-width-direction side surface of projection

3b2 crawler-circumferential-direction side surface of projection

3e lowermost end of projection

4 lug

31 resin member

31e lowermost end of resin member

311 base portion (crawler-width-direction side surface portion of resin member)

311b1 crawler-width-direction side surface of base portion

311b2 crawler-circumferential-direction side surface of base portion

312 connecting portion

312a top surface of connecting portion

313 convex portion

313a first rib

313b second rib

314 concave portion

314a first groove

314b second groove

315 end edge of crawler-width-direction side surface portion

315A crawler-thickness-direction outer circumferential end edge of crawler-width-direction side surface portion

315B2 crawler-thickness-direction outer circumferential end edge of crawler-width-direction side surface portion

315a crawler-width-direction outer corner portion

315b crawler-width-direction inner corner portion

315c intermediate portion (flat portion)

F311o outer surface of crawler-width-direction side surface portion

F311i inner surface of crawler-width-direction side surface portion

BS boundary surface

32 elastic projection

F embedded surface of resin member

100 crawler running apparatus

110 drive wheel (rotating body)

110P pin

120 idling wheel (rotating body)

130 track roller (rotating body)

1. An elastic crawler comprising:
a crawler body formed in an endless belt shape and made of an elastic material;
a projection arranged on an inner circumferential surface of the crawler body and containing an elastic material; and
a resin member forming a part of the projection, wherein
the resin member is embedded in the projection such that a lowermost end of the resin member is arranged at a position higher than a lowermost end of the projection, and
a part of the resin member is exposed on a crawler-width-direction side surface of the projection.

2. The elastic crawler according to claim 1, wherein
other parts of the resin member are exposed on a top surface of the projection.

3. The elastic crawler according to claim 1, wherein
the resin member includes two base portions arranged in a crawler width direction to face each other and at least one connecting portion configured to connect the two base portions to each other, and
a region is partitioned between the base portion and the connecting portion to accommodate other portions forming the projection.

4. The elastic crawler according to claim 1, wherein
the resin member includes at least one of a concave portion and a convex portion on an embedded surface in contact with the projection.

5. The elastic crawler according to claim 1, wherein
a crawler-width-direction outer corner portion of the resin member has a rounded shape from an outer surface of the resin member toward an inner surface of the resin member in a crawler-width-direction cross section view.

6. The elastic crawler according to claim 5, wherein
the resin member includes a flat portion that is continuous with the crawler-width-direction outer corner portion and extends flatly toward the inner surface of the resin member in the crawler-width-direction cross section view.

7. The elastic crawler according to claim 5, wherein
a crawler-width-direction inner corner portion of the resin member has a rounded shape from the inner surface of the resin member toward the outer surface of the resin member in the crawler-width-direction cross section view.

8. The elastic crawler according to claim 1, wherein
other parts of the resin member are exposed on a top surface of the projection,
the resin member includes two base portions arranged in a crawler width direction to face each other and at least one connecting portion configured to connect the two base portions to each other, and
a region is partitioned between the base portion and the connecting portion to accommodate other portions forming the projection.

9. The elastic crawler according to claim 1, wherein
other parts of the resin member are exposed on a top surface of the projection, and
the resin member includes at least one of a concave portion and a convex portion on an embedded surface in contact with the projection.

10. The elastic crawler according to claim 1, wherein
other parts of the resin member are exposed on a top surface of the projection, and
a crawler-width-direction outer corner portion of the resin member has a rounded shape from an outer surface of the resin member toward an inner surface of the resin member in a crawler-width-direction cross section view.

11. The elastic crawler according to claim 1, wherein
the resin member includes two base portions arranged in a crawler width direction to face each other and at least one connecting portion configured to connect the two base portions to each other,
a region is partitioned between the base portion and the connecting portion to accommodate other portions forming the projection, and
the resin member includes at least one of a concave portion and a convex portion on an embedded surface in contact with the projection.

12. The elastic crawler according to claim 1, wherein
the resin member includes two base portions arranged in a crawler width direction to face each other and at least one connecting portion configured to connect the two base portions to each other,
a region is partitioned between the base portion and the connecting portion to accommodate other portions forming the projection, and
a crawler-width-direction outer corner portion of the resin member has a rounded shape from an outer surface of the resin member toward an inner surface of the resin member in a crawler-width-direction cross section view.

13. The elastic crawler according to claim 1, wherein
the resin member includes at least one of a concave portion and a convex portion on an embedded surface in contact with the projection, and
a crawler-width-direction outer corner portion of the resin member has a rounded shape from an outer surface of the resin member toward an inner surface of the resin member in a crawler-width-direction cross section view.

14. The elastic crawler according to claim 1, wherein
other parts of the resin member are exposed on a top surface of the projection,
the resin member includes two base portions arranged in a crawler width direction to face each other and at least one connecting portion configured to connect the two base portions to each other,
a region is partitioned between the base portion and the connecting portion to accommodate other portions forming the projection, and
the resin member includes at least one of a concave portion and a convex portion on an embedded surface in contact with the projection.

15. The elastic crawler according to claim 1, wherein
other parts of the resin member are exposed on a top surface of the projection,
the resin member includes two base portions arranged in a crawler width direction to face each other and at least one connecting portion configured to connect the two base portions to each other,
a region is partitioned between the base portion and the connecting portion to accommodate other portions forming the projection, and
a crawler-width-direction outer corner portion of the resin member has a rounded shape from an outer surface of the resin member toward an inner surface of the resin member in a crawler-width-direction cross section view.

16. The elastic crawler according to claim 1, wherein
other parts of the resin member are exposed on a top surface of the projection,
the resin member includes at least one of a concave portion and a convex portion on an embedded surface in contact with the projection, and
a crawler-width-direction outer corner portion of the resin member has a rounded shape from an outer surface of the resin member toward an inner surface of the resin member in a crawler-width-direction cross section view.

17. The elastic crawler according to claim 1, wherein
other parts of the resin member are exposed on a top surface of the projection,
a crawler-width-direction outer corner portion of the resin member has a rounded shape from an outer surface of the resin member toward an inner surface of the resin member in a crawler-width-direction cross section view, and
the resin member includes a flat portion that is continuous with the crawler-width-direction outer corner portion and extends flatly toward the inner surface of the resin member in the crawler-width-direction cross section view.

18. The elastic crawler according to claim 1, wherein
the resin member includes two base portions arranged in a crawler width direction to face each other and at least one connecting portion configured to connect the two base portions to each other,
a region is partitioned between the base portion and the connecting portion to accommodate other portions forming the projection,
the resin member includes at least one of a concave portion and a convex portion on an embedded surface in contact with the projection, and
a crawler-width-direction outer corner portion of the resin member has a rounded shape from an outer surface of the resin member toward an inner surface of the resin member in a crawler-width-direction cross section view.

19. The elastic crawler according to claim 1, wherein
the resin member includes two base portions arranged in a crawler width direction to face each other and at least one connecting portion configured to connect the two base portions to each other,
a region is partitioned between the base portion and the connecting portion to accommodate other portions forming the projection,
a crawler-width-direction outer corner portion of the resin member has a rounded shape from an outer surface of the resin member toward an inner surface of the resin member in a crawler-width-direction cross section view, and
the resin member includes a flat portion that is continuous with the crawler-width-direction outer corner portion and extends flatly toward the inner surface of the resin member in the crawler-width-direction cross section view.

20. The elastic crawler according to claim 1, wherein
the resin member includes at least one of a concave portion and a convex portion on an embedded surface in contact with the projection,
a crawler-width-direction outer corner portion of the resin member has a rounded shape from an outer surface of the resin member toward an inner surface of the resin member in a crawler-width-direction cross section view, and
the resin member includes a flat portion that is continuous with the crawler-width-direction outer corner portion and extends flatly toward the inner surface of the resin member in the crawler-width-direction cross section view.
